(19) United States
(12) Patent Application Publication
(10) Pub. No.: US 2010/0252034 A1
(43) Pub. Date: Oct. 7, 2010

(54) METHOD AND SYSTEM FOR PORTABLE BREATHING DEVICES

(76) Inventors: Julian T. Ross, McKinney, TX (US); Steven O. Dunford, Lewisville, TX (US); Kraig Kooiman, Flower Mound, TX (US); John Lansdown, McKinney, TX (US); Kathleen Vaughn, Dallas, TX (US); Scott Freeman, Allen, TX (US); Brian Highley, Keller, TX (US); Kevin J. Turner, Highland Village, TX (US); Michael T. Wright, Allen, TX (US)

Correspondence Address: OXYSURE SYSTEMS, INC, 10880 JOHN W. ELLIOT DR., SUITE 600, FRISCO, TX, 75034, US

(21) Appl. No.: 11/623,721

(22) Filed: Jan. 16, 2007

Related U.S. Application Data
(60) Provisional application No. 60/759,255, filed on Jan. 13, 2006.
(60) Provisional application No. 60/814,340, filed on Jun. 16, 2006.
(60) Provisional application No. 60/829,639, filed on Oct. 16, 2006.

(51) Int. Cl. A62B 7/08

(52) U.S. Cl. 128/202.26

(57) ABSTRACT

The present invention provides for a breathing device comprising a housing, oxygen source, water trap, activation mechanism, and breathing apparatus. Operation of the activation mechanism may commence the production of a gas comprising oxygen. The generated oxygen may be bubbled through the water trap prior to being provided to the breathing apparatus attached to the user. Some embodiments may comprise two separate oxygen sources configured to provide distinct flow rates from one another. Other embodiments may comprise a rotating catalyst container configured to evenly and rapidly distribute catalyst upon commencement of the oxygen production. Still other embodiments may comprise a convoluted section of tubing to aid in altering the temperature of the produced oxygen gas.

### CROSS-REFERENCED APPLICATIONS

This application relates to, and claims the benefit of the filing date of, co-pending U.S. Provisional Patent Application Ser. No. 60/759,255, entitled “METHOD AND APPARATUS FOR PROVIDING IMPROVED AVAILABILITY OF BREATHABLE AIR IN A CLOSED CIRCUIT”, filed Jan. 13, 2006, and of co-pending U.S. Provisional Patent Application Ser. No. 60/814,340, entitled “METHOD AND APPARATUS FOR PROVIDING IMPROVED AVAILABILITY OF BREATHABLE AIR IN A CLOSED CIRCUIT”, filed Jun. 16, 2006, and of U.S. Provisional Patent Application Ser. No. 60/829,639, entitled “DOCKABLE SYSTEM FOR PROVIDING IMPROVED AVAILABILITY OF BREATHABLE AIR IN A CLOSED CIRCUIT”, filed Oct. 16, 2006, the entire contents of which are incorporated herein by reference for all purposes.

### BACKGROUND OF THE INVENTION

1. Field of the Invention

The present invention relates to breathing devices and, more particularly, to portable breathing devices.

2. Description of the Related Art

Self-rescuers have been used for a long time in mining, industrial and other hazardous environments or situations. Self-rescuers are used by workers, miners, and others in these types of perilous situations to provide a means to breathe or escape during the occurrence of hazardous, toxic, or otherwise dangerous conditions. Typically, normal ambient air contains around 21% oxygen. Expiratory air, expelled from a person, usually contains a lower percentage of oxygen, approximately 15% or less. However, in an emergency situation this expiratory air can be re-breathed or reused, provided that the expiratory air is sufficiently recycled and supplemented with additional oxygen. Recycling expiratory air is accomplished by removing carbon dioxide (CO₂) from the expiratory air. This is the basic principle by which many self-rescuers function today. Expiratory air from the user of a self-rescuer is recycled by a CO₂ scrubber to produce scrubbed or recycled air. Generated oxygen is added to the recycled air and then provided back to the user as breathable inhalation air. The cycle of inspiration, expiration, scrubbing, and oxygen supplementation continues in this fashion in a circuit closed to input from the external environment.

Since the user is breathing a relatively closed circuit of his/her own expired air, it follows that an initial supply of air may be needed in order to start the process cycle. In other words, the user may need to exhale or blow into the system so that the cycle can begin to generate breathable air. Alternatively, some current systems come with a starter in order to initiate the process of the self-rescuer. A starter is usually a small device able to produce an initial bolus of oxygen, typically around 6 liters. However, if the self-rescuer is incorrectly deployed by a user, the oxygen from this starter may be lost. This can represent a significant problem for the user as the user must then provide an initial tidal volume of air, which may have to be drawn from a potentially toxic surrounding environment.

Another challenge with some current systems is that an oxygen source is needed in order to supplement the air recycled from the user. Compressed tanks of oxygen cannot adequately perform this function since they represent an explosion hazard. Consequently, compressed tanks of oxygen are unsafe to keep or store in sufficient quantities in underground mines and in other dangerous environments. Small compressed tanks of oxygen may be used by rescue teams for their own air supply systems, but as a general rule the small compressed tanks are not used with personal self-rescuers. Self-rescuers, usually referred to as Self-Contained Self-Rescuers (SCSRs), are the types of units used by miners or other personnel trapped or otherwise confronted with a hazardous environment. The SCSRs need to be person wearable (i.e., very portable). Consequently, the SCSRs would ideally be small and very light weight. This would make the use of a compressed oxygen tank in an SCSR generally infeasible or impractical. In addition to the need to provide a supplemental source of oxygen to initiate the rebreathing process, a supplemental source of oxygen is also needed to extend the time of the supply period of breathable air and to maintain the oxygen percentage in the available breathable air at or above the required safety levels. For many situations, these safety levels are mandated by government entities such as the National Institute of Occupational Safety and Health (NIOSH). For example, a minimum safety level of 19.5% oxygen for a particular rated duration may be a usable standard for some systems.

Another significant challenge with the current systems in use is that they are typically single use systems. If the system has exceeded a rated duration and the user requires more time, the user may gain more time (i.e., more breathable air) only by removing the entire expired system and thereafter “donning” an entirely new system. This donning procedure can take a significant amount of time and is typically performed while the user is under extreme duress, such as may be the case during an emergency escape from a hazardous situation. In addition, the user most likely has to hold their breath during the exchange due to the hazardous ambient environment. Failure to perform the procedure correctly and timeously (i.e., in a timely manner) or allowing panic to set in can be fatal to the user.

In some current systems the chemical reactions used to scrub CO₂ from the expired air, remove moisture, and/or generate the supplemental oxygen, are all exothermic. The heat generated during these reactions may be transferred directly to the recycled air. Subsequently, the temperature of the air inhaled by the user may increase with time, ultimately reaching uncomfortable or dangerous levels. The excess heat may be sufficiently high enough to cause burns or otherwise damage the user's lungs or tracheal areas. Additionally, the excess heat may result in pain or burns proximate to the contact areas of the unit assembly and breather tubes.

### SUMMARY OF THE INVENTION

An embodiment of the present invention provides a system that may deliver sustaining air. The system may comprise a housing, an oxygen source, a breathing interface, and an activation mechanism. The oxygen source may produce a gas that comprises oxygen. The breathing interface may be configured to provide sustaining air to the user. The activation mechanism may be operated to commence production of the oxygen by the oxygen source.

### BRIEF DESCRIPTION OF THE DRAWINGS

For a more complete understanding of the present invention and the advantages thereof, reference is now made to the following Detailed Description taken in conjunction with the accompanying drawings, in which:

FIG. 1 illustrates a general cross-sectional view of a breathing device in accordance with an embodiment of the present invention;

FIG. 2 illustrates an exploded assembly diagram of a housing of the breathing device shown in FIG. 1;

FIG. 3 illustrates an enlarged plan view of a top surface of the top housing of FIG. 2;

FIG. 4A illustrates an enlarged plan view of a lower surface of the bottom housing of FIG. 2;

FIG. 4B illustrates a cross-sectional view of the bottom housing of FIG. 4A as viewed along line B-B;

FIG. 5A illustrates an upper perspective view of a cartridge of the breathing device of FIG. 1;

FIG. 5B illustrates a lower perspective view of the cartridge of FIG. 5A;

FIG. 6 illustrates a cross-sectional view of the cartridge of FIG. 5A taken along line 6-6;

FIG. 7A illustrates an enlarged upper perspective plan view of a reaction membrane of the oxygen source of the cartridge of FIG. 5A;

FIG. 7B illustrates an enlarged lower perspective view of the reaction membrane of FIG. 7A;

FIG. 7C illustrates a cross-sectional assembly view of the reaction membrane of FIG. 7A, taken along the line C-C;

FIG. 8A illustrates an enlarged upper perspective view of a cup spinner of the oxygen source of the cartridge of FIG. 5A;

FIG. 8B illustrates an enlarged lower perspective view of the cup spinner of FIG. 8A;

FIG. 9 illustrates an enlarged cross-sectional view of a reaction plunger of the oxygen source of FIG. 6;

FIG. 10A illustrates an enlarged perspective view of a scrubber membrane of the scrubber of FIG. 6;

FIG. 10B illustrates a cross-sectional view of the scrubber membrane of FIG. 10A, taken along the line B-B;

FIG. 11 illustrates a cross-sectional view of a scrubber plunger of the scrubber of FIG. 6;

FIG. 12 illustrates a perspective view of a reservoir bag of the breathing device of FIG. 1;

FIG. 13 illustrates an enlarged lower assembly plan view of an activation mechanism on a lower surface of the top housing of FIG. 2;

FIG. 14 illustrates a rear assembly view of the breathing device of FIG. 1 showing various attachment mechanisms and a breathing apparatus;

FIG. 15 illustrates an enlarged detail view of a wye-connector of an embodiment of a breathing apparatus;

FIG. 16 illustrates an enlarged detail view of another embodiment of a breathing apparatus;

FIG. 17 illustrates an exploded assembly view of the breathing device of FIG. 1;

FIG. 18 illustrates a cross-sectional view of the storage cover of FIG. 17 taken along line 18-18;

FIG. 19 illustrates a perspective assembly view showing a cartridge from above comprising anti-activation devices.

FIG. 20 illustrates a general cross-sectional view of a breathing device in accordance with another embodiment of the present invention;

FIG. 21 illustrates an exploded assembly view of the housing components of the breathing device of FIG. 20;

FIG. 22A illustrates an upper view of a top housing of FIG. 21;

FIG. 22B illustrates a cross-sectional view of the top housing of FIG. 22A taken along line B-B;

FIG. 23 illustrates an exploded assembly view of a cartridge of FIG. 20;

FIG. 24A illustrates a top view of the cartridge of FIG. 23;

FIG. 24B illustrates a cross-sectional view of the cartridge of FIG. 24A taken along line B-B;

FIG. 25 illustrates a bottom perspective view of the cartridge of FIG. 23;

FIG. 26A illustrates a top perspective view of a water trap of FIG. 20;

FIG. 26B illustrates an exploded bottom perspective view of the water trap of FIG. 26A;

FIG. 27 illustrates a bottom view of the top housing of FIG. 21; and

FIG. 28 illustrates an assembly view of the breathing device of FIG. 20 showing the breathing apparatus and inhalation tube attached.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning well known features and elements have been omitted inasmuch as such details are not considered necessary to obtain a complete understanding of the present invention, and are considered to be within the understanding of persons of ordinary skill in the relevant art.

The entire contents of Provisional Patent Application Ser. No. 60/759,255, entitled “METHOD AND APPARATUS FOR PROVIDING IMPROVED AVAILABILITY OF BREATHABLE AIR IN A CLOSED CIRCUIT”, filed Jan. 13, 2006, and of co-pending U.S. Provisional Patent Application Ser. No. 60/814,340, entitled “METHOD AND APPARATUS FOR PROVIDING IMPROVED AVAILABILITY OF BREATHABLE AIR IN A CLOSED CIRCUIT”, filed Jun. 16, 2006, and of co-pending U.S. Provisional Application Ser. No. 60/829,639, entitled “DOCKABLE SYSTEM FOR PROVIDING IMPROVED AVAILABILITY OF BREATHABLE AIR IN A CLOSED CIRCUIT”, filed Oct. 16, 2006, are incorporated herein by reference for all purposes.

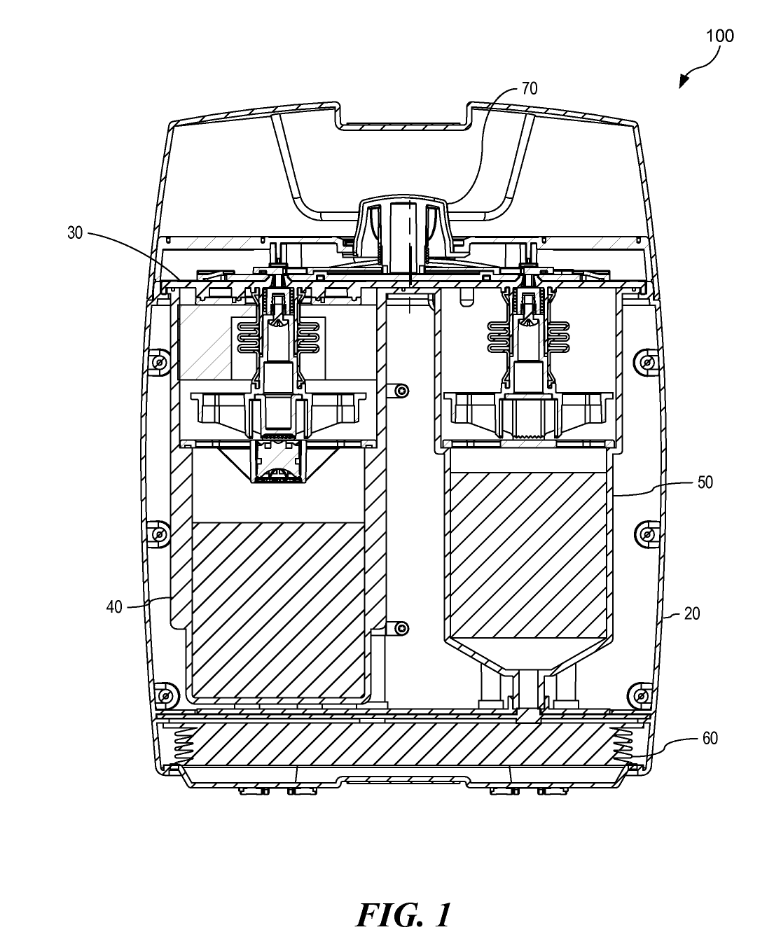

Turning now to the drawings, FIG. 1 shows a cross-sectional view of an illustrative embodiment of the present invention. In this drawing, reference numeral 100 generally indicates a SCSR breathing device 100. The breathing device 100 may comprise a housing 20 and a dockable cartridge 30 located within the housing 20. The dockable cartridge 30 may further comprise an oxygen source 40 and a CO₂ scrubber 50, fluidly communicating with a reservoir bag 60. The cartridge 30 may be actuated via an activation device 70. The various components of the breathing device 100 will be described in more detail in the following illustrative embodiment.

### Housing

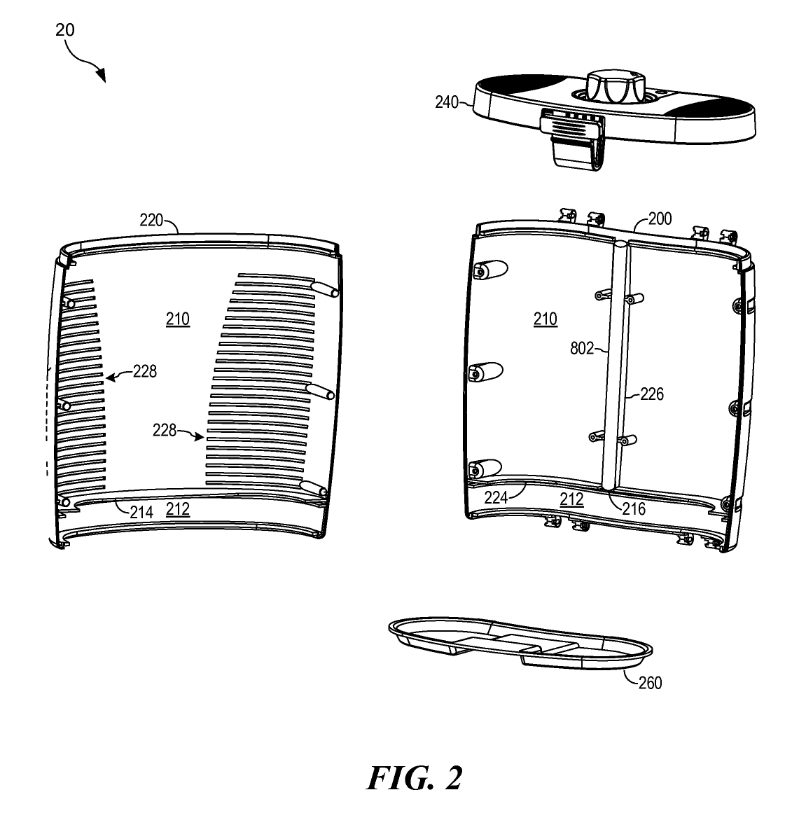

Turning now to FIG. 2, the housing 20 may comprise a rear housing 200, a front housing 220, a top housing 240, and a bottom housing 260. The various housing components may be made of material suitable for exposure to hazardous and toxic environments. In addition, the material may be configured to withstand long term storage without deterioration or breakage. The breathing device 100 (FIG. 1) may be configured to be easily carried by a user, therefore, the material should be lightweight in addition to providing appropriate strength. Some examples of material for the housing 20 comprise acrylonitrile butadiene styrene (ABS) and polycarbonate/ABS alloy (PC/ABS), polyvinylchloride (PVC), polystyrene (PS), and acrylic-polymethyl methacrylate (PMMA), among others. Additionally, several resin systems such as fluoropolymers including PTFE (trade name Teflon® sold by DuPont), acetal (polyoxymethylene), liquid crystal polymers (LCP), nylon, polyetheretherkeytone (PEEK), high-density polyethylene (HDPE), polyurethane (PU), polypropylene, and some thermosetting resins including epoxies, polyimides, and urethanes, among others. Further, metals including aluminum, stainless steel, and magnesium alloys, in addition to engineered materials including carbon fiber, among others, may also be used for the housing 20. The materials described are intended as illustrative examples only, and are not considered to form an exhaustive list. Other materials may be used in addition to or in place of the materials previously discussed.

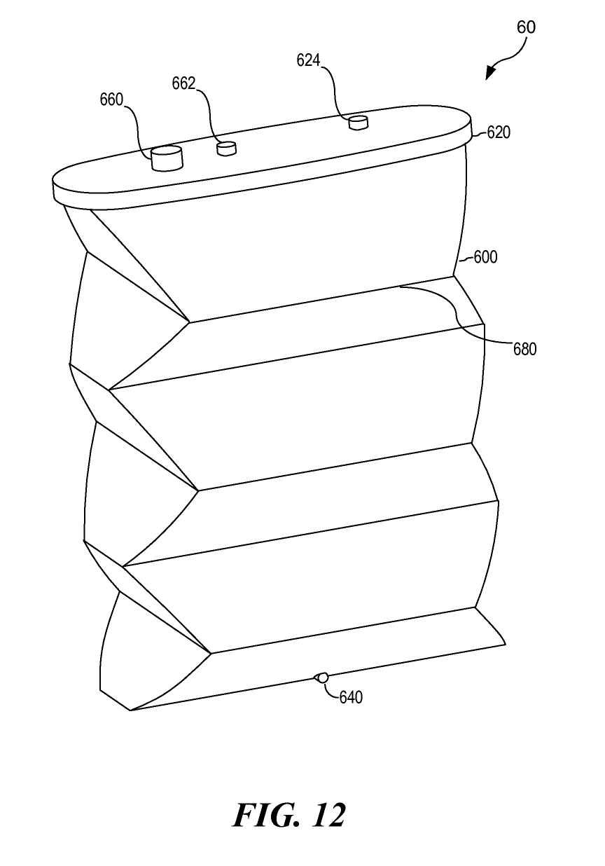

The rear housing 200 of this illustrative embodiment may be hingedly coupled to the top housing 240 and the bottom housing 260. The rear housing 200 may be substantially concave and designed to accommodate the rear of a cartridge 30 (FIG. 1) described later. An upper ledge of the rear housing 200 proximate to the top housing 240 may substantially correspond to a top cartridge plate 300 (shown in FIG. 5A) of the cartridge 30. The concavity of the rear housing 200 may partially define an interior of an assembled housing 20. This interior may be separated into a cartridge section 210 and a reservoir section 212 by a protruding reservoir interface support 224. As an example, the reservoir interface support 224 may be in the form of a channel, shelf, groove, or substantially form a U-shape when viewed in cross-section. The reservoir interface support 224 may be configured to removably fix the reservoir interface plate 620 described later (shown in FIG. 12) with regard to the upper and lower edges of the rear housing 200 respectively proximate to the top housing 240 and the bottom housing 260 of an assembled housing 20. Additionally, the coupling between the reservoir interface support 224 and the reservoir interface plate 620 may be configured so that the reservoir interface plate 620 is removable, allowing the housing 20 to be re-used after an emergency situation. In the illustrative embodiment shown, the reservoir interface plate 620 may slide into engagement with the reservoir interface support 224 in a direction substantially perpendicular to the general plane of the rear most surface of the rear housing 200.

The reservoir interface support 224 may be shown in this exemplary embodiment as a substantially continuous element extending across the entire interior surface of the rear housing 200. However, the reservoir interface support 224 should not be limited by this example. The reservoir interface support 224 may be formed of one or more discontinuous segments across a portion of the interior surface of the rear housing 200.

Although a channel shaped protrusion may be shown in FIG. 2, embodiments of the reservoir interface support 224 of the present invention should not be limited to this single configuration. Tabs, grooves, and interlocking contours may be examples of some of the other methods of removably fixing the reservoir interface plate 620 (FIG. 12) to the rear housing 200. In addition, an embodiment may be configured so as to permanently fix the reservoir interface plate 620 to the rear housing 200 through the use of chemical adhesives or material welding for example. The reservoir interface plate 620 may be permanently fixed to the housing 20 for applications in which a breathing device 100 (FIG. 1) may be disposed or sanitized after use for an emergency situation. Further, a separate reservoir interface plate 620 is shown. However, the reservoir interface plate 620 may be integrally formed from one or more of the components of the housing 20.

The reservoir interface support 224 may comprise lower inhalation tube passageway accommodators 216. The accommodators 216 are shown in this illustrative embodiment as substantially U-shaped notches (for example) located in an upper and lower portion of the reservoir interface support 224. The accommodators 216 may be configured to accept the outer diameter of the lower inhalation tube 802 and/or the associated inhalation tube connections. However, the reservoir interface plate 620 (FIG. 12) may be configured so as to eliminate any need for accommodators 216 in the reservoir interface support 224 (e.g., such as repositioning the location of the inhalation tube connection on the reservoir interface plate 620). In addition, although the reservoir interface support 224 of this embodiment is shown as a substantially continuous element across the interior surface of the rear housing 200, the reservoir interface support 224 may be made of one or more discontinuous segments 224 across a portion of the interior surface of the rear housing 200. The discontinuities may also eliminate the need for specified accommodators 216.

The rear housing 200 may further comprise an inhalation tube attachment area 226. The inhalation tube attachment area 226 may be located on an interior side of the rear housing 200 and may be configured to removably attach a lower inhalation tube 802. The lower inhalation tube 802 may be removably attached to the front housing through threadably secured u-channels, grooves, clips, and cable ties, among other attachment mechanisms. As with the reservoir interface plate 620 (FIG. 12), an embodiment of the present invention enables the replacement of the lower inhalation tube 802 along with the reservoir bag 60 (FIG. 1) after use for a single emergency. This may permit the housing 20 to be recycled and retained for future emergency use. However, another embodiment of the present invention may provide for permanently attaching the lower inhalation tube 802 to the rear housing 200 via chemical adhesive, and welding or riveting of supports, among others. Permanently attaching the lower inhalation tube 802 to the front cover may be appropriate for applications in which the breathing device 100 is to be disposed of or sanitized after a single emergency use. Additionally, the lower inhalation tube 802 may be integrally formed within the rear housing 200 and coupled to the reservoir interface plate 620 via an appropriate mechanism.

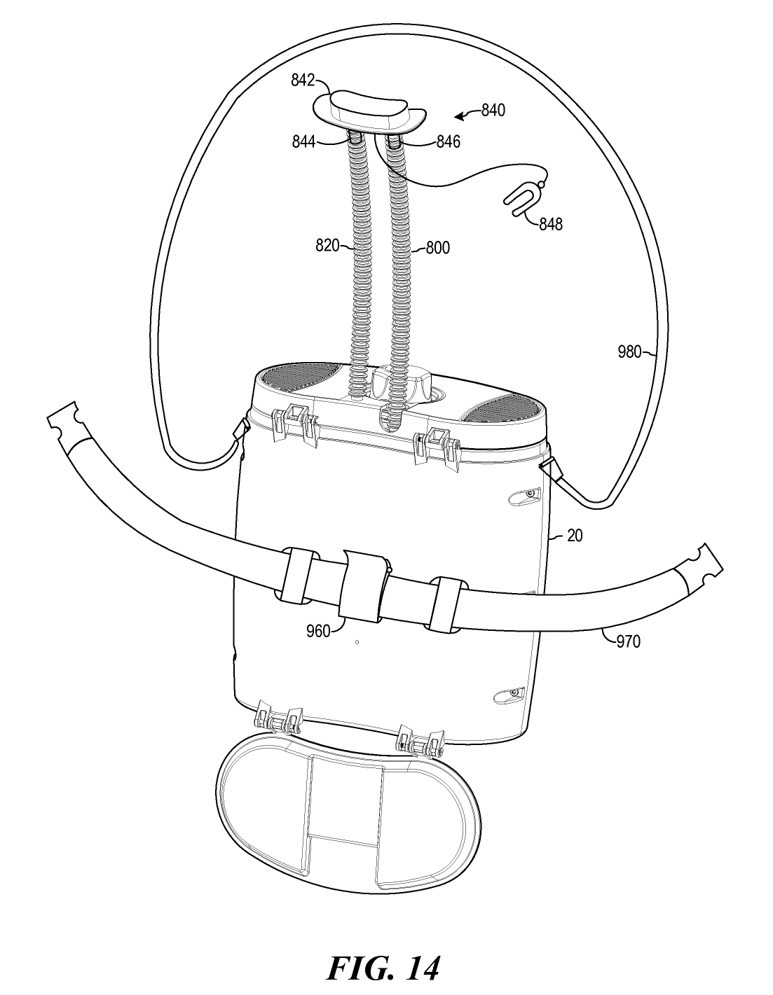

The rear side of the rear housing 200 may comprise features to enable the breathing device 100 (FIG. 1) to be easily attachable to a user. Examples (shown in FIG. 14) such as spring loaded clips 960, belts 970, and shoulder straps 980, among others, are readily adaptable to the rear of the rear housing 200 or to the housing 20 in general. Potential design considerations for attachment devices may include both speed of attachment and ease of attachment, in addition to reliability and strength.

The front housing 220 of this illustrative embodiment may be largely symmetrical to the rear housing 200 and also configured to accommodate the cartridge 30 (FIG. 1). As such, the front housing 220 may be substantially convex when viewed from the front. In addition, an upper ledge of the front housing 220, proximate to the top housing 240 in an assembled housing 20, may substantially correspond to a top cartridge plate 300 (shown in FIG. 5A) of the cartridge 30. When the front housing 220 is joined to the rear housing 200, the front housing 220 and the rear housing 200 define the interior of the housing 20. The front housing 220 may be removably joined or secured to the rear housing 200 through the use of screws, snap fits, belts, clasps, and interlocking features, among others. The front housing 220 may be removable in order to facilitate the exchange of the reservoir interface plate 620 (FIG. 12), reservoir bag 60 (FIG. 1), and lower inhalation tube 802, described later, after a single emergency use. Additionally, the front housing 220 may be permanently secured to the rear housing 200 in certain embodiments in which the breathing device 100 (FIG. 1) is considered to be disposable or is sanitized after a single emergency use. The methods of permanently securing the front housing 220 to the rear housing 200 may comprise chemical adhesive, rivets, and welding, among others.

The front housing 220 may also comprise a reservoir interface support 214. As with the reservoir interface support 224 of the rear housing 200, the reservoir interface support 214 may separate the interior of an assembled housing 20 into a cartridge section 210 and a reservoir section 212. The configuration of the reservoir interface support 214 of the front housing 220 may correspond to the configuration of the reservoir interface support 224 of the rear housing 200. Similar to the reservoir interface support 224, the reservoir interface support 214 may be configured to removably fix the reservoir interface plate 620 (FIG. 12) in position relative to upper and lower edges of the front housing 200, which may be respectively proximate to the upper housing 240 and the bottom housing 260 in an assembled housing 20. Alternatively, the reservoir interface plate 620 may be permanently secured to the reservoir interface support 214.

The front housing 220 may comprise temperature control devices 228, shown in FIG. 2 as a plurality of through openings, for example, slots. The temperature control devices 228 may enable air to flow through the interior of the housing 20 so as to convectively reduce the temperature of the interior. The temperature control devices 228 may take many active and/or passive forms, including, but not limited to, louvers, fins, thermally conductive material, endothermic reactions, and powered fans. The temperature control devices 228 of this embodiment may be directed through the front of the front housing 220, enabling the heat to travel away from a user wearing the breathing device 100 in a conventional manner. In addition to reducing the temperature of the interior of the housing 20, the temperature control devices 228 may also aid in controlling the temperature of the inhalation gases passing through the lower inhalation tube 802.

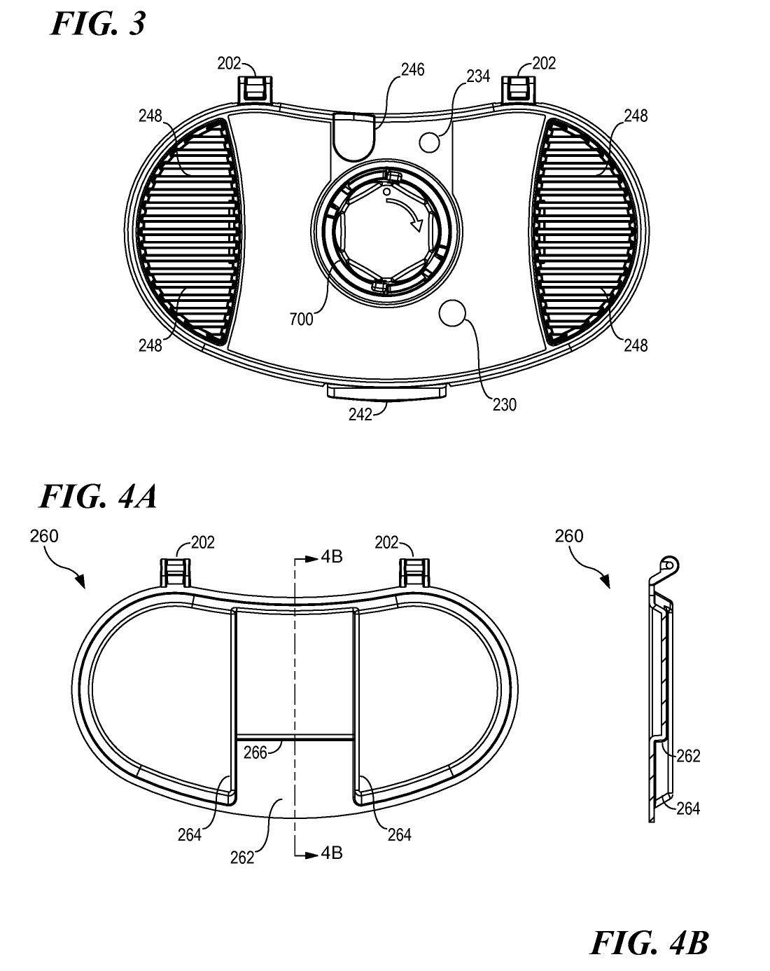

Turning now to FIG. 3, the top housing 240 may be hingedly connected to the rear housing 200 or the front housing 220 via one or more hinges 202. Additionally, the top housing 240 may be hingedly connected via a flexible membrane, living hinge, or otherwise rotatable device, among others. As an example, the illustrative embodiment of the present invention of FIG. 3 shows the top housing 240 hingedly coupled with the rear housing 200 (FIG. 2) via two hinges 202. The top housing 240 may be configured to openly close off the top of the interior of the housing 20 (FIG. 2). The top housing 240 may comprise a tab 242 located proximate to an edge of the top housing 240 opposite of the hinged connection. The tab 242 may be used to temporarily secure the top housing 240 in a position covering the interior of the housing 20. The top housing 240 may be pivotally opened in order to provide access to the interior of the housing 20 for the replacement/installation of dockable cartridges 30 (FIG. 1) and/or to facilitate the joining of various connections. Alternatively, in certain other embodiments, hingedly connecting the top housing 240 may replaced by removably securing the top housing 240 to the front housing 220 (FIG. 2) and the rear housing 200 through the use of a snap fit, clasps, fasteners, and clips, among others. The top housing 240, in addition to the front housing 220, rear housing 200, and the reservoir interface plate 620 (FIG. 12), define the cartridge section 210 (FIG. 2) of the interior of the housing 20.

The top housing 240 may comprise accommodation for the inhalation tube 800 and/or the expiration tube 820 (both shown in FIG. 14). An example of an accommodation for the inhalation tube 800 and/or the lower inhalation tube 802 (FIG. 2) may be a substantially U-shaped housing tube notch 246, configured to accommodate the outer diameter of the inhalation and/or lower inhalation tubes 800, 802 and associated connectors. This housing tube notch 246 may allow the top housing 240 to be manipulated without requiring the disconnection of the upper and/or lower inhalation tubes 800, 802. The housing tube notch 246 may therefore enable a user to continue breathing in from the reservoir bag 60 (FIG. 1) while an expired cartridge 30 (FIG. 1) is replaced, a so called hot-swapping of the cartridges 30. Although a substantially U-shaped housing tube notch 246 may be shown in FIG. 3, embodiments of the present invention are not limited to this geometric configuration. Any shape or design may be used as long as the shape or design is configured to allow the top housing 240 to be opened without requiring the disconnection of the upper and/or lower inhalation tubes 800, 802.

The top housing 240 may comprise an expiration orifice 234 to enable the establishment of a passageway from the expiration tube 820 (FIG. 14) to the scrubber 50 (shown in FIG. 5A). The expiration tube 820 may have to be disconnected from the scrubber 50 during the hot-swapping procedure described above. However, the expiration tube 820 may remain attached to the top housing 240 during the procedure. In addition, the expiration orifice 234 may further comprise a one-way valve so as to automatically close or seal off the distal end of the expiration tube 820 while the top housing 240 is opened. The one-way valve may allow the user to continue to exhale expired gases while inhibiting the entry of the ambient atmosphere into the expiration tube while the cartridge 30 (FIG. 1) is replaced. This may reduce the risk of contamination of the air supply for a user of the system.

The top housing 240 in some illustrative embodiments may comprise a function indicator orifice 230. The function indicator orifice 230 may enable a user to view a function indicator 306 (shown in FIG. 5A). A function indicator 306 may be a component of the cartridge 30 (FIG. 1) that is configured to indicate the functioning status of the breathing device 100 (FIG. 1). In some embodiments, the function indicator 306 may be a spinner physically reacting to the flow of oxygen through the system. In other embodiments, the function indicator 306 may be an light emitting diode (LED) illuminating to indicate the production or flow of oxygen through the system. The function indicator 306 may be actuated by the flow of gas, temperature, chemical reaction, or pressure, for example. By observing the function indicator 306 via the function indicator orifice 230, a user may be able to verify that the cartridge 30 is functioning as intended.

The top housing 240 may comprise components of an activation mechanism 70 (FIG. 1). The illustrative embodiment shows an actuator 700, such as a knob for example, rotatably extending through the top housing 240. The activation mechanism 70 will be described in more detail later. The actuator 700 of the activation mechanism 70 may enable a user to externally actuate a cartridge 30 (FIG. 1) located within the housing 20 (FIG. 1).

The top housing 240 may comprise temperature control devices 248, shown in FIG. 3 as a plurality of through openings, for example, slots. The temperature control devices 248 may enable air flow through the interior of the housing 20 (FIG. 1) in order to aid in reducing or cooling the temperature of the interior. The temperature control devices 248 may take many active and/or passive forms, including, but not limited to, louvers, fins, thermally conductive material, endothermic reactions, and fans.

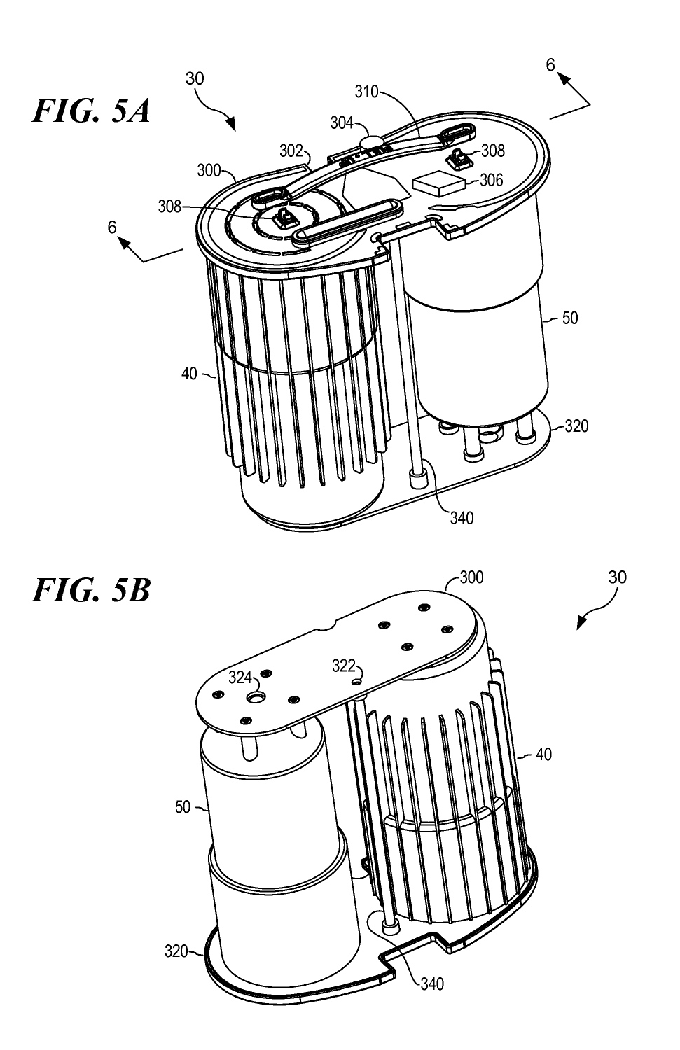

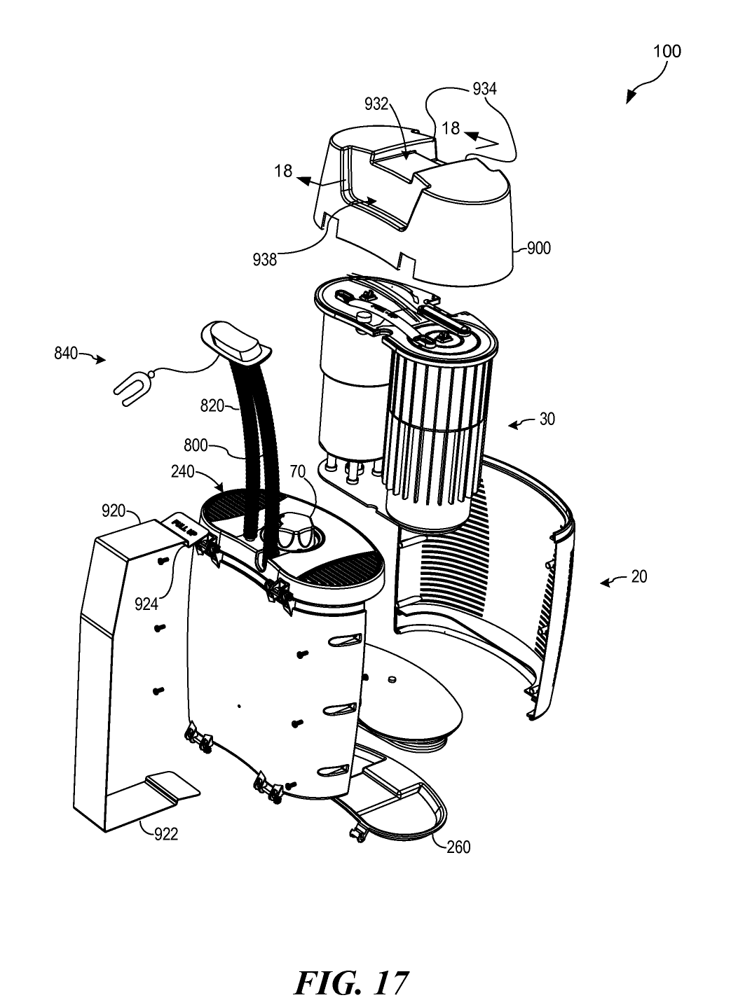

Turning now to FIG. 4A, the bottom housing 260 may comprise one or more hinges 202, and may be hingedly or pivotally connected to the front housing 220 (FIG. 2) or the rear housing 200 (FIG. 2). In this illustrative embodiment, the bottom housing 260 may be shown as hingedly connecting to the rear housing 200 via two hinges 202, for example. The bottom housing 260 is configured to openly close off the lower end of the housing 20 (FIG. 1). Opening of the bottom housing 260 may enable the reservoir bag 60 (FIG. 1) to extend from within the reservoir section 212 of the interior of the housing 20. In certain other embodiments, the bottom housing 260 may be slidingly coupled to the front housing 220 and the rear housing 200, or lightly snap fitted to the rest of the housing 20, for example. The bottom housing 260 may be held in position through the use of a storage clip 920 (shown in FIG. 17). The bottom housing 260 of this illustrative embodiment may be represented as remaining attached to the housing 20 when the reservoir bag 60 is deployed, but the bottom housing 260 may separate from the housing 20 upon deployment of the reservoir bag 60. The bottom housing 260 may define the reservoir section 212 along with the front housing 220, rear housing 200, and reservoir interface plate 620 (FIG. 12).

The bottom housing 260 may comprise a bottom housing clip channel 262 defined between opposing bottom housing walls 264. The bottom housing clip channel 262 may be lower in height than the surrounding surfaces of the bottom housing 260 so as to prevent inadvertent or accidental movement of the storage clip 920 in a longitudinal direction of the bottom housing 260. The bottom housing clip channel 262 may further comprise a bottom housing clip retention ledge 266 to abut and temporarily retain a corresponding lower clip retention ledge 922 (shown in FIG. 17) of the storage clip 920 (FIG. 17) in a transverse direction of the bottom housing 260. An example of a cross-section of a configuration of the bottom housing clip channel 262 may be seen in FIG. 4B. Although a relatively straight bottom housing clip retention ledge 266 is shown in FIGS. 4A and 4B, many different configurations may be employed to temporarily retain a storage clip 920 in the transverse and longitudinal directions of the bottom housing 260. For example, a circular orifice in one of the storage clip 920 and the bottom housing 260 and a corresponding cylindrical protrusion in the other of the storage clip 920 and the bottom housing 260 may be used, among others.

### Cartridge

Turning now to FIG. 5A, an embodiment of the present invention may comprise a replaceable, dockable, cartridge 30. The cartridge 30 may further comprise an oxygen source 40, a scrubber 50, a top cartridge plate 300, a bottom cartridge plate 320, and an oxygen source tube 340. The cartridge 30 may be configured to be removable and replaceable during the course of an emergency. By continuously exchanging an expired cartridge 30 with a new cartridge 30, a user may have an indefinite duration of breathable air. As stated previously, the breathing device 100 (FIG. 1) may be configured to be hot swappable so as to enable a user to continue inhaling through an inhalation tube 800 (FIG. 14) and exhaling through the exhalation tube 820 (FIG. 14) while the cartridge 30 is being replaced. The cartridge 30 may be configured to removably fit within the cartridge section 210 of the interior of the housing 20 (see FIG. 2).

The top cartridge plate 300 may comprise a cartridge tube notch 302, expiration connection 304, a function indicator 306, activation tabs 308, and a cartridge handle 310. The cartridge tube notch 302 may function similar to the housing tube notch 246 of the top housing 240 (see FIG. 3). The cartridge tube notch 302 may be configured to accommodate the outer diameter of the lower inhalation tube 802 (FIG. 2) and/or associated connections to the inhalation tube 800 (FIG. 14). In addition, the cartridge tube notch 302 may allow the cartridge 30 to be removed from the cartridge section 210 (FIG. 2) of the interior of the housing 20 (FIG. 2) without requiring the lower inhalation tube 802 to be disconnected from the inhalation tube 800. In other words, the user may remain in fluid communication with the reservoir bag 60 (FIG. 1) via the inhalation tube 800 while the cartridge 30 is being replaced.

The top cartridge plate 300 may comprise an expiration connection 304. The expiration connection 304 may be fluidly coupled with the scrubber 50. The expiration connection 304 may comprise a self-sealing connection. The self-sealing connection may normally be in a closed or sealed off configuration. Upon the closing of the top housing 240 (FIG. 3) over an enclosed cartridge 30, a fluid connection may be automatically established between the expiration connection 304 and the expiration orifice 234 (FIG. 3). Opening of the top housing 240 may break a the fluid connection between the expiration connection 304 and the expiration orifice 234.

Some embodiments of the present invention may comprise a function indicator 306. The function indicator 306 may be positioned on the top surface of the top cartridge plate 300 so as to be visible via the function indicator orifice 230 (FIG. 3). The function indicator 306 may be located within or interact with the gas flow stream exiting from the oxygen source 40. When the cartridge 30 has been activated, the oxygen source 40 may commence the production of oxygen. The oxygen may then interact with the function indicator 306. As the oxygen interacts with the function indicator 306, a user may observe the movement of a spinner (not shown) or other material within a transparent function indicator 306 via the function indicator orifice 230. An example of a function indicator 306 described in this embodiment may be commonly known as a spinner. However, embodiments of the present invention are not to be limited to this device. Any method of indicating the functioning of the cartridge 30 such as light emitting diodes (LEDs), pressure and/or temperature indictors (e.g., pressure and/or temperature gauges, color changing materials, etc.), audible devices, among others, may be used to verify the functioning of a cartridge 30. In addition, the function indicator 306 may be actuated via chemical reactions (e.g., changing color to indicate a high percentage of oxygen), pressure, temperature, or material flow, for example.

The activation tabs 308 may be positioned on a top surface of the top cartridge plate 300 so as to interact with the activation mechanism 70 (FIG. 1). In certain embodiments, closing of the top housing 240 (FIG. 3) may engage the activation mechanism 70 with the activation tabs 308. The interaction between the activation tabs 308 and the activation mechanism 70 may enable a user to externally activate a cartridge 30 located within the cartridge section 210 of the interior of the housing 20 (see FIG. 2).

An embodiment of the top cartridge plate 300 may comprise a cartridge handle 310 to readily enable the removal of an expired cartridge 30 from the cartridge section 210 of the interior of the housing 20 (see FIG. 2). The cartridge handle 310 may be made of an insulative or thermally non-conductive material in order to inhibit the heating of the cartridge handle 310 due to an exothermic oxygen generating reaction of the oxygen source 40. The user may then be able to manipulate an expired cartridge 30 with a reduced risk of injury. The cartridge handle 310 may be secured to the cartridge 30 through the use of slots and mounting protrusions or fasteners for example, enabling the cartridge handle 310 to slidably move between a flat orientation against the upper surface of the top cartridge plate 300, and a raised orientation more conducive to grasping by the hand of a user. The material used for the cartridge handle 310 may be of a durometer selected for a comfortable tactile response while maintaining an engagement between the slots and mounting protrusions or fasteners.

The oxygen source 40 and the scrubber 50 may be fixedly attached to the top cartridge plate 300 and the bottom cartridge plate 320. The components of the cartridge 30 may form a relatively rigid structure such that a user may establish a sealed fluid connection between the bottom cartridge plate 320 and the reservoir interface 620 (FIG. 12) by pressing upon the top cartridge plate 300. Additionally, the cartridge 30 may be removed as a unit by pulling on the cartridge handle 310, simultaneously disconnecting the bottom cartridge plate 320 from the reservoir interface plate 620.

### Oxygen Supply Tube

Turning now to FIG. 5B, the oxygen supply tube 340 may be directly fluidly coupled to the oxygen source 40. Alternatively, the oxygen supply tube 340 may be fluidly coupled to an oxygen flow outlet of a function indicator 306 (FIG. 5A). In such a case, an oxygen flow inlet of the function indicator 306 may then be fluidly coupled to the oxygen source 40 or an oxygen channel or passageway (e.g., located within the top cartridge plate 300) that is in turn, fluidly coupled to the oxygen source 40. In other embodiments, the oxygen supply tube 340 may be directly coupled to the oxygen channel or passageway that is fluidly coupled to the oxygen source 40. The oxygen supply tube 340 may direct the flow of oxygen catalytically generated by the oxygen source 40 to the reservoir bag 60 (FIG. 1). The oxygen supply tube 340 may be connected to the bottom cartridge plate 320 via a self-sealing or one-way valve. The self-sealing valve may automatically open upon a connection established between the oxygen outlet 322 in the bottom cartridge plate 320 and the oxygen inlet 622 located in the reservoir interface plate 620 (see FIG. 12). The position of the oxygen outlet 322 is configured to coincide with that of the oxygen inlet 622 when a cartridge 30 is assembled within the housing 20 (FIG. 1). The sealing or one-way valve may inhibit the introduction of the surrounding atmosphere into the oxygen supply tube 340. Therefore, a cartridge 30 may be protected from contamination by a hazardous ambient environment prior to insertion within the cartridge section 210 of the interior of the housing 20 (see FIG. 2).

The oxygen supply tube 340 may be made of a highly thermally conductive material in order to facilitate cooling of the catalytically produced oxygen prior to delivery of the oxygen to the reservoir bag 60 (FIG. 1). Alternatively, the oxygen supply tube may be made of polyvinylchloride (PVC) tubing such as Nalgene 180 high temperature PVC tubing made by NALGENE Labware in order to have a high temperature resistance. The oxygen supply tube 340 may also have an extended pathway or be coupled within or about a radiating device (e.g., a finned tube or radiator) in order to further cool the generated oxygen prior to inhalation by the user. Other illustrative embodiments of the present invention may use additional or alternative methods to reduce the temperature of the generated oxygen. Some examples of these methods include, but are not limited to, passing the oxygen supply tube 340 through materials comprising an endothermic reaction, use of phase change materials to dissipate thermal energy, bubbling of the oxygen gas, and active cooling of the passageway via a powered fan, among others.

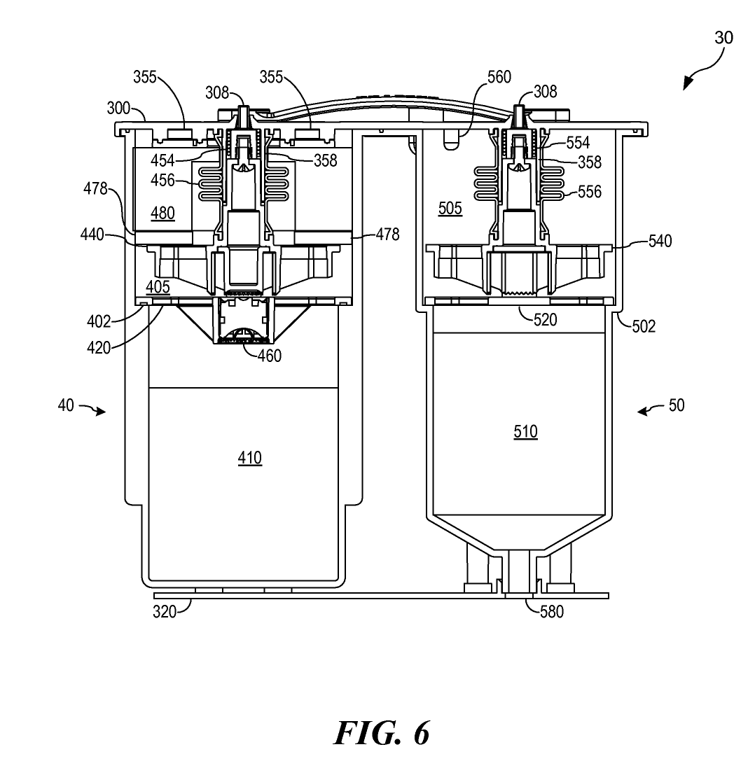

Turning now to FIG. 6, a cross-section of the cartridge 30 may comprise an oxygen source 40, a scrubber 50, a top cartridge plate 300 and a bottom cartridge plate 320. The oxygen source 40 may comprise a reaction chamber 400 divided into an upper chamber 405 and a lower chamber 410 by a reaction membrane 420 abutting a reaction shelf 402. The reaction membrane 420 may further comprise a cup spinner 460. The oxygen source 40 may further comprise a reaction plunger 440, resilient boot 456, and resilient member 454. The top cartridge plate 300 may comprise down tubes 358, and upper cartridge passageways 355. The scrubber 50 may comprise a scrubber chamber 500 divided into an upper scrubber chamber 505 and a lower scrubber chamber 510 by a scrubber membrane 520 abutting a scrubber shelf 502. The scrubber 50 may further comprise a scrubber plunger 540, scrubber entrance 560 and scrubber exit 580. The reaction plunger 440 and the scrubber plunger 540 may interact with the top cartridge plate 300 via activation tabs 308. The various components of the cartridge 30 may now be described in more detail as follows.

### Oxygen Source

An embodiment of the catalytic oxygen source 40 may generate oxygen by combining an appropriate oxidizing material (reagent) and a catalyst in water (accelerant). The water may also contain an additive to alter or modify the freezing point or the boiling point of the water. For example, an additive such as a salt with a high level of solubility and low toxicity such as NaCl, LiCl, KCl, and CaCl, among others, may help to prevent damage in situations where the placement of the breathing device 100 (FIG. 1) may otherwise result in the freezing or boiling of the accelerant. There may be a potential to freeze the accelerant during storage (e.g., on an airliner or in an area without environmental control) or during the shipping of the breathing device 100. Conversely, the accelerant may otherwise boil if shipped through a desert location during hot summer months. Various components of the breathing device 100 may be damaged by expanding water transforming into ice or by a pressure build-up resulting from steam. Further, a frozen accelerant may take too much time to react with the reagent and catalyst in a time critical emergency. Additionally, by maintaining the accelerant in a liquid form through the use of additives, the breathing device 100 may activate normally even when exposed or stored in relatively extreme conditions.

The oxygen source 40 may generate oxygen on demand via a catalytic chemical reaction that occurs at temperatures considered to minimize any potential thermal hazards to the user. The oxygen source 40, including activation, management, and control methods and apparatuses are more fully described in the following patent applications. These patent applications are incorporated by reference herein as the “Ross Catalytic Oxygen Patent Applications.”
1. Ser. No. 10/718,131, entitled “Method & Apparatus for Generating Oxygen,” filed Nov. 20, 2003, (Docket No. ROSS 2864000)
2. Ser. No. 10/856,591, entitled “Apparatus and Delivery of Medically Pure Oxygen,” filed May 28, 2004, (Docket No. ROSS 2934000)
3. Ser. No. 11/045,805, entitled “Method and Apparatus for Controlled Production of a Gas,” filed Jan. 28, 2005, (Docket No. ROSS 3050000)
4. Ser. No. 11/158,993, entitled “Method and Apparatus for Controlled Production of a Gas,” filed Jun. 22, 2005, (Docket No. ROSS 3050001)
5. Ser. No. 11/159,016, entitled “Method and Apparatus for Controlled Production of a Gas,” filed Jun. 22, 2005, (Docket No. ROSS 3050002)
6. Ser. No. 11/158,377, entitled “Method and Apparatus for Controlled Production of a Gas,” filed Jun. 22, 2005, (Docket No. ROSS 3050003)
7. Ser. No. 11/158,362, entitled “Method and Apparatus for Controlled Production of a Gas,” filed Jun. 22, 2005, (Docket No. ROSS 3050004)
8. Ser. No. 11/158,618, entitled “Method and Apparatus for Controlled Production of a Gas,” filed Jun. 22, 2005, (Docket No. ROSS 3050005)
9. Ser. No. 11/158,989, entitled “Method and Apparatus for Controlled Production of a Gas,” filed Jun. 22, 2005, (Docket No. ROSS 3050006)
10. Ser. No. 11/158,696, entitled “Method and Apparatus for Controlled Production of a Gas,” filed Jun. 22, 2005, (Docket No. ROSS 3050007)
11. Ser. No. 11/158,648, entitled “Method and Apparatus for Controlled Production of a Gas,” filed Jun. 22, 2005, (Docket No. ROSS 3050008)
12. Ser. No. 11/159,079, entitled “Method and Apparatus for Controlled Production of a Gas,” filed Jun. 22, 2005, (Docket No. ROSS 3050009)
13. Ser. No. 11/158,763, entitled “Method and Apparatus for Controlled Production of a Gas,” filed Jun. 22, 2005, (Docket No. ROSS 3050010)
14. Ser. No. 11/158,865, entitled “Method and Apparatus for Controlled Production of a Gas,” filed Jun. 22, 2005, (Docket No. ROSS 3050011)
15. Ser. No. 11/158,958, entitled “Method and Apparatus for Controlled Production of a Gas,” filed Jun. 22, 2005, (Docket No. ROSS 3050012)
16. Ser. No. 11/158,867, entitled “Method and Apparatus for Controlled Production of a Gas,” filed Jun. 22, 2005, (Docket No. ROSS 3050013)
17. Ser. No. 11/438,651, entitled “Method and Apparatus for Generating Oxygen,” filed May 22, 2006, (Docket No. ROSS 2864003)
18. Ser. No. 11/558,374, entitled “Method and Apparatus For Delivering Therapeutic Oxygen Treatments,” filed Nov. 9, 2006, (Docket No. ROSS 3353001)
19. Ser. No. 11/560,304, entitled “Method and Apparatus for Delivering Oxygenated Heated Vapor in Skin Care Applications,” filed Nov. 15, 2006, (Docket No. ROSS 3361002)
20. Ser. No. 11/567,196, entitled “Method and Apparatus for Controlled Production of a Gas,” filed Dec. 5, 2006, (Docket No. ROSS 3367001)
21. Ser. No. 60/699,094, entitled “Method and Apparatus for Generating Oxygen,” filed Jul. 14, 2005, (Docket No. ROSS 2864002)
22. Ser. No. 60/735,011, entitled “Oxygen Patch,” filed Nov. 15, 2005, (Docket No. ROSS 3353000)
23. Ser. No. 60/736,786, entitled “Method and Apparatus for Delivering Oxygenated Heated Vapor in Skin Care Applications,” filed Nov. 15, 2005, (Docket No. ROSS 3361000)
24. Ser. No. 60/742,436, entitled “Flexible Reaction Chamber with Frangible Seals and Activation Methods,” filed Dec. 5, 2005, (Docket No. ROSS 3367000)
25. Ser. No. 60/762,675, entitled “Expandable Housing Generator,” filed Jan. 27, 2006, (Docket No. ROSS 3388000)
26. Ser. No. 60/763,121, entitled “Method and Apparatus for Delivering Oxygenated Heated Vapor in Skin Care Applications,” filed Jan. 27, 2006, (Docket No. ROSS 3361001)

In an illustrative embodiment of a cartridge 30, as shown in cross-section in FIG. 6, the oxygen source 40 may comprise a reaction chamber 400 separated into an upper chamber 405 and a lower chamber 410. The reaction chamber 400 may be secured to the top cartridge plate 300 and the bottom cartridge plate 320. The reaction chamber 400 may be sealed against the underside surface of the top cartridge plate 300 through ultrasonic, laser, or thermal welding, for example. The reaction chamber 400 may also comprise cooling fins/reinforcing ridges to strengthen and increase the degree thermal conductivity through the reaction chamber 400 walls (e.g., by allowing air to flow around the reaction chamber 400). The upper chamber 405 may be separated from the lower chamber 410 by a reaction membrane 420. The upper chamber 405 and the lower chamber 410 may separately store components of the catalytic reaction used to generate oxygen. This may allow a cartridge 30, which comprises an oxygen source 40, to have a sufficient storage life. In some examples, a storage life of three years or more may be considered sufficient. Additionally, separation of the components of the catalytic process used to generate oxygen may enable the oxygen source 40 to commence the production of the oxygen based upon user demand.

The reaction chamber 400 may be exposed to a maximum reaction temperature of approximately 200° Fahrenheit at a pressure of approximately 1 psi. The breathing device 100 (FIG. 1) may comprise a relief valve may with a cracking pressure of 14 psi to prevent or inhibit over pressurization of the reaction chamber 400. The material for the reaction chamber 400 may be any polymer, for example, able to meet the above conditions. A preferred material may be any polymer with a heat deflection temperature (HDT) of at least 220° Fahrenheit. Materials that may meet these requirements include, but are not limited to, acrylonitrile butadiene styrene (ABS) and polycarbonate/ABS alloy (PC/ABS). Additionally, several resin systems such as fluoropolymers including PTFE (e.g., trade name Teflon® sold by DuPont), acetal (polyoxymethylene), liquid crystal polymers (LCP), some high temperature nylons, polyetheretherkeytone (PEEK), high-density polyethylene (HDPE) may be usable in low flow rate applications (i.e., low temperature <170® Fahrenheit reactions), polyurethane (PU), polypropylene, and some thermosetting resins including epoxies, polyimides, and urethanes, among others. Further, metals including aluminum, stainless steel, and thixotropic molding of magnesium alloys, among others, may also be used for the reaction chamber 400. The materials described are intended as illustrative examples only, and are not considered to form an exhaustive list. Other materials may be used in addition to or in place of the materials previously discussed.

### Reaction Membrane

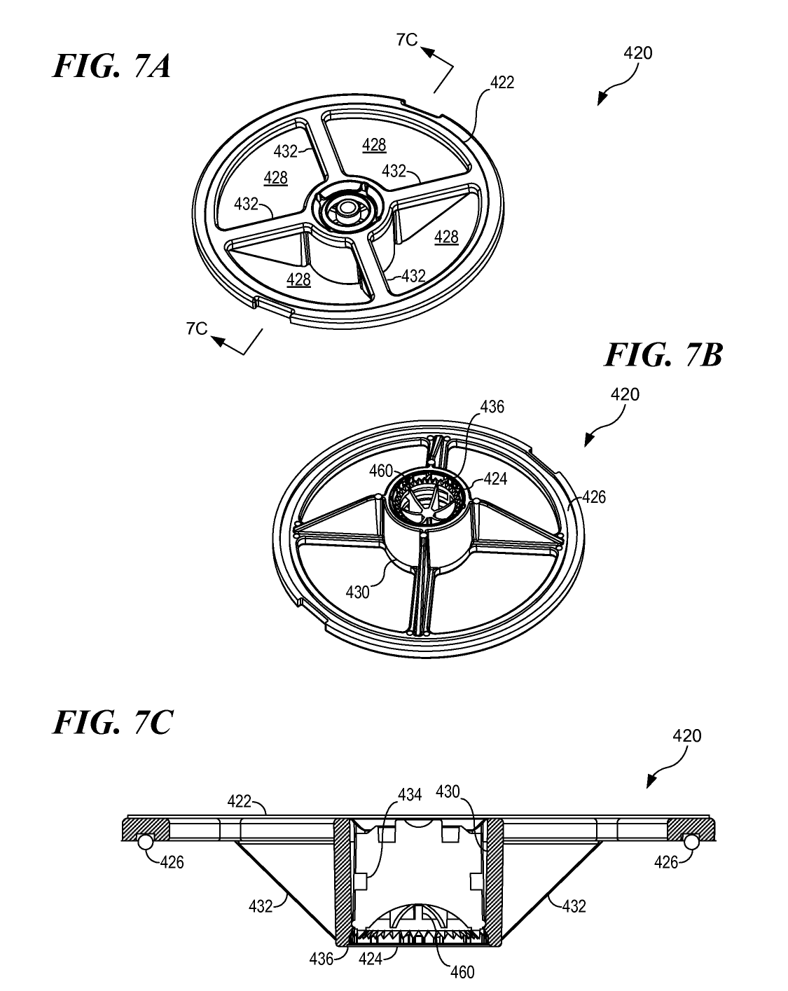

In certain embodiments, the reaction membrane 420 sealingly separates the upper chamber 405 from the lower chamber 410. Turning to FIGS. 7A, 7B, and 7C, the reaction membrane 420 may comprise a first covering 422 and a second covering 424. The first covering 422 and the second covering 424 may be impervious to liquid, or waterproof. Some embodiments of the first covering 422 and the second covering 424 may comprise a foil made of laminated materials such as aluminum, adhesive, an oxygen barrier, and a liquid barrier. Examples of these materials may comprise polyethylene (PE), polyethylene terephthalate (PET), and polyvinylchloride (PVC), among others. The first covering 422 and the second covering 424 may support the liquid weight of the water component of the catalytic oxygen reaction during shipping and storage, and yet be relatively easy to breach, pierce and/or cut. The reaction membrane 420 may further comprise an approximately cylindrical storage compartment configured to accommodate the cup spinner 460. The storage compartment may be respectively sealed by the first covering 422 and the second covering 424.

The reaction membrane 420 may comprise a seal 426, which may abut the mating surfaces of the reaction membrane 420 and the reaction shelf 402 that may be located between the upper and lower chambers 405, 410. The seal 426 may be a resilient material such as a rubber o-ring for example. The seal 426, along with the first covering 422 may maintain separation of the accelerant (e.g., water) in the upper chamber 405, and the reagent in the lower chamber 410. The catalyst may be maintained within the cup spinner 460 located in a storage compartment 430 between the first covering 422 and the second covering 424.

The storage compartment 430 of the reaction membrane 420 may be supported by one or more support arms 432. The support arms 432 may divide the substantially circular (for example) reaction membrane 420 into one or more substantially pie shaped openings 428. The first covering 422 may cover and seal the one or more substantially pie shaped openings 428 along with one end of the storage compartment. The second covering 424 may cover and seal another end of the storage compartment. The storage compartment 430 of the reaction membrane 420 may comprise a catalyst cup spinner 460, a resilient cup device 434, and storage anti-rotation protrusions 436.

### Cup Spinner

The initial rate of oxygen production may be affected by the sequence or the timing of the introduction of the accelerant and the catalyst. Slow initiation of the reaction may occur if the catalyst is not adequately dispersed in the reagent. This may result from poor distribution, clumping, and/or retention of the catalyst within the cup spinner 460 or storage compartment of the reaction membrane 420. Slow initiation may be a significant problem in emergency scenarios where higher flow rates of oxygen are needed to purge a breathing system 100 (FIG. 1) or are needed to provide sufficient volumes of oxygen to a user in a hazardous environment in which an immediate source of oxygen may save their lives (e.g., such as may occur in a mining accident). Fast or slow initiation of the reaction may eventually produce the same amount of oxygen, however, it may be the timing of the delivery rate that is critical.

Active, forceful distribution of the catalyst may be an important factor in increasing the onset of the reaction via the disrupting or the breaking up of clumps of catalyst into smaller particles for a faster reaction and even distribution. Various methods and devices may be used to disperse the catalyst across the entire surface of the reagent, maximizing the surface area where the reaction may occur. Some examples of these catalyst dispersion methods and devices may be a separate internal plunger resiliently actuated within the cup spinner 460, thermo-dynamic materials able to force out catalyst when subjected to temperature differentials, pneumatic or hydraulic pressure, and explosive or expansive chemical reaction of materials contained along with the catalyst within the cup spinner 460, among other methods. However, previous methods of just washing a catalyst from a catalyst container using an accelerant may result in the clumping of the catalyst, or the catalyst may end up floating on top of the accelerant. Using compressed or rapidly expanding gas to propel the catalyst across the surface of the reagent may break up some clumps of catalyst, but at an increased cost and weight penalty for providing the compressed or expanding gas. An illustrative embodiment of the present invention may comprise a combination of a rapidly rotating cup spinner 460 in which accelerant may be washed through to facilitate the even and effective distribution of catalyst. However, the rotating cup spinner 460 may produce enough centrifugal force on its own to distribute the catalyst. Although a rotating cup spinner 460 may be shown and described in this embodiment of the present invention, an embodiment of the present invention may not be limited to this method of catalyst dispersion.

The cup spinner 460 may be supported within a storage compartment 430 of the reaction membrane 420 by support arms 432 defining a plurality of openings 428 (e.g., four openings are shown in FIGS. 7A and 7B). The cup spinner 460 may be enclosed between a first covering 422, covering the openings 428 and the storage compartment 430 comprising the cup spinner 460, and the second covering 424 covering an opposing end of the storage compartment 430. When the first covering 422 is breached, the openings 428 may facilitate the mixing of chemical components and/or the transmission of generated gas. Additionally, piercing the first covering 422 may allow the reaction plunger 440 to contact the top of the cup spinner 460 and force the cup spinner 460 through the second covering 424.

The cup spinner 460 may comprise a resilient cup device 434 (FIG. 7C) configured to impart a rotating motion to the cup spinner 460 as the reaction plunger 440 is activated. An example of the resilient cup device 434 may be a clock spring, among others. In this example, a clock spring device may be selected as an embodiment of a resilient cup device 434 in order to minimize the space required for resilient cup device 434, reduce weight, optimize the volume capacity of the cup spinner 460 for the catalyst, simplify the installation requirements, enable ease of activation, and provide adequate force for the near instantaneous distribution of the catalyst through a rotating action of the cup spinner 460. This method may provide for uniform and consistent distribution of the catalyst even when the breathing device 100 (FIG. 1) may not be in a preferred upright orientation.

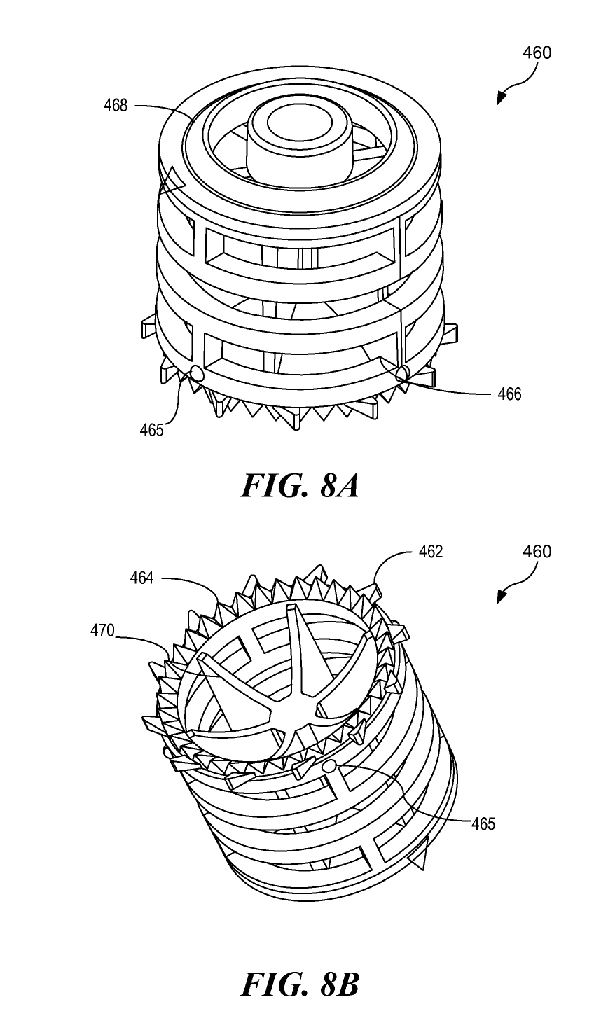

Turning now to FIGS. 8A and 8B, the cup spinner 460 may comprise anti-reversal protrusions 462 and cutting protrusions 464. The anti-rotation protrusions 462 may engage with corresponding storage anti-rotation protrusions 436 located within the cylindrical volume of the storage compartment 430 of the reaction membrane 420 comprising the cup spinner 460 (see FIG. 7B). When assembled, the cup spinner 460 may be inserted into a storage compartment 430 of the reaction membrane 420 with a rotating potential force stored in the resilient cup device 434 (see FIG. 7C). The anti-reversal protrusions 462 and corresponding storage protrusions 436 within the storage compartment may counteract the bias of the resilient cup device 434 during storage and shipping. However, during activation once the cup spinner 460 passes through the second covering 424 (i.e., disengages the anti-reversal protrusions 462 from the corresponding storage protrusions 436), the cup spinner 460 may be free to rotate relative to the reaction membrane 420, distributing the catalyst stored within the cup spinner 460. The cutting protrusions 464 may enable the cup spinner 460 to readily cut through the second covering 424.

The cup spinner 460 may comprise one or more protrusions 465 located around the circumference of the cup spinner 460. The one or more protrusions 465 may fit into corresponding detents or grooves located in the storage compartment 430 of the reaction membrane 420 (see FIGS. 7B and 7C). The protrusions 465 and corresponding features in the storage compartment 430 help in maintaining the position of the cup spinner 460 within the storage compartment 430 during shipping and storage of the breathing device 100 and cartridge 30 (see FIG. 1). The cup spinner 460 may further comprise a mating surface 468 configured to abut a reaction plunger 440 (FIG. 6) during activation of the cartridge 30. The cup spinner 460 may further comprise a plurality of orifices 466 and a plurality of fins 470.

The assembly of the cup spinner 460 within the storage compartment 430 of the membrane 420 may now be described by returning to FIGS. 7A, 7B, and 7C. FIGS. 8A and 8B may be used to show details of the cup spinner 460. The resilient cup device 434 may be connected to a slot in the cup spinner 460 proximate to the center or mid-point of a central axis (i.e., relative to approximately half of the length of the cup spinner 460). Any location on the cup spinner 460 may be chosen for attaching the resilient cup device 434 to the cup spinner 460. However, the center of the cup spinner 460 relative to the central axis shown in FIG. 7C of the illustrative embodiment of the present invention may reduce the potential binding of the resilient cup device 434 during the motion of the cup spinner 460 as the cup spinner 460 leaves the storage compartment 430 of the reaction membrane 420. Another end of the resilient cup device 434 may be slidably engaged (e.g., along a portion of the length of the cylindrical volume) to the reaction plunger 440. The resilient bias between the attachment of the resilient cup device 434 to the cup spinner 460 and the reaction membrane 420 facilitates the impartation of a rotating motion to the cup spinner 460 upon actuation. Alternatively, a keeping device (not shown) such as a clock spring keeper (e.g., such as for an embodiment of a resilient cup device 434 comprising a clock spring) or equivalent device may prevent the binding of the cup spinner 460 during ejection from the storage compartment 430 of the reaction membrane 420.

The cup spinner 460 may be maintained at an appropriate position within the cylindrical volume of the storage compartment 430 due to protrusions 465 on the cup spinner 460 and matching detent features within the storage compartment 430. These features may help to prevent inadvertent activation of the catalytic oxygen reaction during rough handling or drop forces. The protrusions 465 and matching features may maintain the cup spinner 460 at a position relative to the length of the cylindrical volume of the storage compartment 430 and still allow the cup spinner 460 to be expelled from the reaction membrane 420 during activation.

When the cup spinner 460 is rotating, the catalyst may be ejected through a plurality of orifices 466 located around a cylindrical perimeter of the cup spinner 460, for example. The orifices 466 may be separated by fins 470 configured to break up clumps of catalyst and evenly distribute or expel the catalyst radially outward, away from the cup spinner 460. This forceful distribution of the catalyst helps to mitigate problems from any potential clumping or compaction that may have occurred during a lengthy storage and/or vibration during shipping. Additionally, in certain embodiments the cup spinner 460 may be completely expelled from the reaction membrane 420. Ejection from the storage compartment of the reaction membrane 420 may enable the cup spinner 460 to directly interact with the reagent, allowing any catalyst remaining within the cup spinner 460 to participate in the catalytic oxygen generating reaction. Alternatively, the cup spinner 460 may at least partially remain within the storage compartment 430 of the reaction membrane 420 in order to effectively distribute the catalyst via the complete expansion of the resilient cup device 434.

The cup spinner 460 may be forced through the second covering 424 by a reaction plunger 440. An embodiment of the cup spinner 460 may comprise a mating surface 468 such as a ring or button (for example) located on the top surface of the cup spinner 460, proximate to the reaction plunger 440 (FIG. 6). The mating surface 468 may interact with an opposing surface of the reaction plunger 440 in order to facilitate the cutting of the first covering 422 by the reaction plunger 440 as the breathing device 100 (FIG. 1) is activated.

### Reaction Plunger

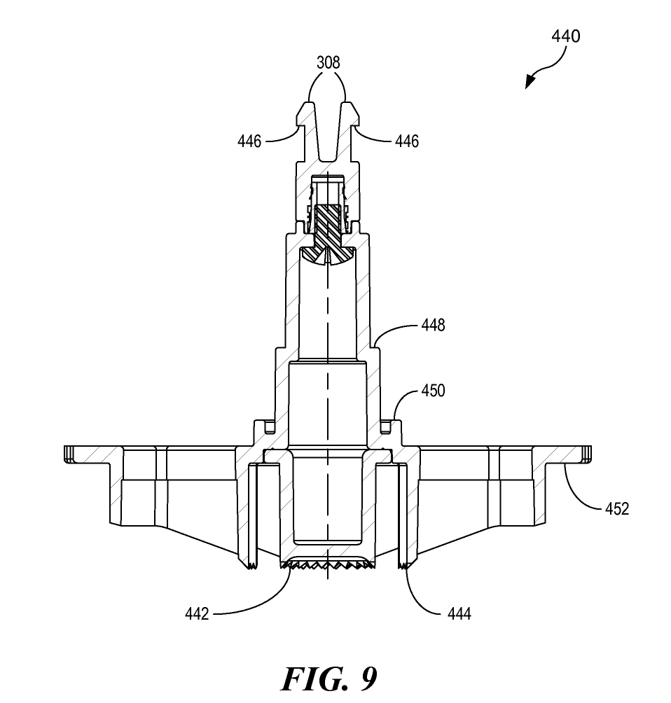

Turning now to FIG. 9, the reaction plunger 440 may comprise a first cutting edge 442 and a plurality of second cutting edges 444. The first cutting edge 442 may substantially correspond to a mating surface 468 of the cup spinner 460. In this illustrative example, the first cutting edge 442 and the mating surface 468 of the cup spinner 460 (see FIG. 8A) have an approximately circular contact area. The first cutting edge 442 may also be used to cut through the first covering 422 and travel onward to expel the cup spinner 460 through the second covering 424 (see FIG. 7C). The second cutting edges 444 may be used to cut through the first covering 422 and create passageways for the flowing of accelerant and catalytically produced oxygen gas. The first cutting edge 442 and the second cutting edge 444 may be formed of an acetal resin engineering plastic, such as polyoxynethylene (POM), polytrioxane, and polyformaldehyde, among others. Delrin™ sold by Dupont is another type of acetal resin engineering plastic that may be used for the first cutting edge 442 and the second cutting edge 444. The Delrin™ or other lubricious material may be dissimilar to the material used for the reaction membrane 420 and top cartridge plate 300 (FIG. 6). The dissimilar materials may aid in preventing the sticking or welding of the materials during the assembly process or long term storage with applied forces.

The reaction plunger 440 may further comprise a reaction plunger lip 452. As an example of an embodiment of the present invention, the second cutting edges 444 may comprise an approximately pie shaped hollow projection extending below the reaction plunger lip 452. In some cases, the outer perimeter of the hollow projections of the second cutting edges 444 may correspond to the inner perimeter of the membrane openings 428 (FIG. 7A). Although an approximately pie shaped hollow projection may be shown for the second cutting edges 444, an embodiment of the reaction plunger 440 may not be limited to this configuration. Any configuration and number of cutting edges capable of piercing the first covering 422 (FIG. 7A) and establishing communication passageways between the lower chamber 410 and the upper chamber 405 (see FIG. 6) may be used. Alternatively, another embodiment of the present invention may comprise a gas permeable but liquid impervious first covering 422 and no second cutting edges 444. The reaction plunger lip 452 may be used to prevent the overextension of the reaction plunger 440 beyond the reaction shelf 402 of the reaction chamber 400 (see FIG. 6). The open design of the reaction plunger 440 may facilitate the reaction plunger 440 passing through the accelerant with a minimal loss of force.

The reaction plunger 440 may comprise a circumferential ledge 448 and a boot holder 450 (explained later). The reaction plunger 440 may be actuated through the stored potential energy of a resilient member 454 (FIG. 6), shown in this illustrative example as a coil spring, interacting with the circumferential ledge 448 and a lower surface of the top cartridge plate 300 (FIG. 6). In addition, the resilient member 454 may be externally bounded by the down tube 358 (FIG. 6) surrounding the upper portion of the reaction plunger 440 in an assembled state. However, the reaction plunger 440 may also be actuated through many other methods, including, but not limited to, solenoids, mechanical levers, electro-mechanical devices, and hydraulic or pneumatic pressure, among others. In this exemplary embodiment, the reaction plunger 440 is retained in a position proximate to the reaction membrane 420 via at least one activation tab 308. The biasing amount of the resilient member 454 may be configured at a level sufficient to enable the reaction plunger 440 to push the cup spinner 460 through the second covering 424 (see FIG. 6).

The activation tabs 308 of the reaction plunger 440 may each comprise a retention ledge 446. Embodiments of the activation tabs 308 may comprise two tennons or square pins for example. The retention ledge 446 may abut a reinforced upper surface of the top cartridge plate 300 (FIG. 6) in an assembled state. The retention ledge 446 may be configured to withstand the biasing force of a resilient member 454 (FIG. 6) or other activation energizer. Actuation of the oxygen source 40 of the cartridge 30 (see FIG. 6) may involve moving the activation tabs 308 such that the retention ledges 446 are disengaged from the top surface of the top cartridge plate 300. This enables the reaction plunger 440 to be forceably driven through the reaction membrane 420 (FIG. 6), consequently releasing the catalyst from within the cup spinner 460 (FIG. 6), and commencing the catalytic reaction generating oxygen gas.

Returning to FIG. 6, the down tube 358 and activation tabs 308 may help ensure that the proper orientation of the assembled reaction plunger 440 within the reaction chamber 400. The reaction plunger 440 may be further aligned and/or guided by one or more protruding guide rails located on the side walls of the reaction chamber 400. The guide rails may slidably engage a corresponding notch, keyway, or indention located along the perimeter of the reaction plunger 440. Additionally, an outer circumference of the first cutting edge 442 (FIG. 9) may slidably abut a corresponding inner perimeter of the storage compartment 430 of the reaction membrane 420 (FIGS. 7B and 7C), facilitating the alignment of the reaction plunger 440 along a central axis of the reaction chamber 400. Alignment along the center axis of the reaction chamber 400 may ensure the penetration of the first covering 422 (FIG. 7A) at an appropriate point so as to minimize the possibility of the reaction plunger 440 interfering with or coming in contact with the reaction membrane 420.

The produced oxygen gas may flow through the breached reaction membrane 420 and through a foam breaker 478 and a filter 480. In some situations, the oxygen generating reaction may create bubbles and foam as the gas is released. If left unchecked, the foam may expand to fill the entire volume of the reaction chamber 400 and may also carry catalyst away from the surface of the reagent, thereby slowing the reaction. The cartridge 30 may comprise a foam breaker 478 in the oxygen sources 40. A foam breaker 478 may be positioned just prior to a filter 480 in respect to the flow direction of generated oxygen gas. The foam breaker 478 may break foam bubbles lower in the oxygen source 40, closer to the ongoing reaction. The location may facilitate the return of the catalyst to the point of the reaction.

The foam breaker 478 may comprise open celled foams, coarsely woven materials, or expanded extrusions, among others. The material for the foam breaker 478 may comprise polypropylene, polyethylene, among other materials inert to the catalytic oxygen generating reaction specifics and not configured to absorb water (i.e., hydrophobic). Various types of materials used in the foam breaker 478 may create an open cell structure that may facilitate the flow through of gas but effectively break down the bubbles of the foam, potentially suppressing the growth of a foam head within the oxygen source 40. The foam breaker 478 may act as a pre-filter, breaking down bubbles, speeding the release of oxygen, and facilitating the return of water to the catalytic reaction. Additionally, the foam breaker 478 may create a tortuous path for the generated oxygen gas, allowing the condensing of water and a cooling of the oxygen gas.

The oxygen gas may continue to travel through top cartridge passageways 355 located within the top cartridge plate 300 and into the reservoir bag 60 (FIG. 1) via the oxygen supply tube 340 (FIGS. 5A and 5B). The reaction plunger 440 may comprise a boot holder 450 (FIG. 9) configured to retain a resilient boot 456. The resilient boot 456 may effectively seal an area surrounding the down tube 358 and the upper portion of the reaction plunger 440. The resilient boot 456 may be fastened to a down tube 358 of the top cartridge plate 300 and to the shaft of the reaction plunger 440 at the boot holder 450. The resilient boot 456 may separate the resilient member 454 from the accelerant during storage and shipping of the cartridge 30. The resilient boot 456 may further prevent or inhibit the flow of generated oxygen though the down tube 300 comprising the activation tabs 308 and the resilient member 454.

In an illustrative embodiment of the present invention, the resilient boot 456 is shown with three convolutions for example. However, one or more or no convolutions may be required to allow the resilient boot 456 to expand from an initial pre-activation length to a post-activation length. The resilient boot 456 may comprise stiffening features at each end corresponding to matching features in the reaction plunger 440 and the down tube 358. The features may create a tortuous path to inhibit the flow of gas around the resilient boot 456. However, clamps, o-rings, and other sealing devices may be used to ensure a gas tight seal between the resilient boot 456 and the reaction plunger 440 and down tube 358.

### Scrubber

As shown in FIG. 6, the scrubber 50 may be fixedly attached and sealed to the top cartridge plate 300 and the bottom cartridge plate 320. The scrubber 50 may be attached with fasteners, adhesives, material welding, and interlocking configurations, among others. The scrubber 50 may comprise a scrubber chamber 500. The scrubber chamber 500 may comprise an upper scrubber chamber 505 and a lower scrubber chamber 510. The upper scrubber chamber 505 and the lower scrubber chamber 510 may be separated by a hermetically sealing scrubber membrane 520 abutting a scrubber shelf 502. The upper scrubber chamber 505 may comprise a scrubber plunger 540. The lower scrubber chamber 510 may comprise chemicals configured to remove undesired components from expired gas flowing through the scrubber 50. An example of undesired components may be excess CO₂. The scrubber 50 in some embodiments may comprise soda-ash/soda-sorb or potassium superoxide (KO₂), for example, as an active ingredient to remove excess CO₂. In addition, the scrubber 50 may comprise calcium oxide (CaO) to remove other gasses, such as, but not limited to, sulfur dioxide and hydrogen sulfide. The scrubber 50 may comprise a scrubber entrance 560 and a scrubber exit 580.

The scrubber entrance 560 of the scrubber 50 may be directly connected to the expiration connection 304. Alternatively, the scrubber entrance 560 may be connected to the expiration connection 304 via an expiration channel or passageway (e.g., located within the top cartridge plate 300). The scrubber exit 580 may be fluidly connected to a recycled air exit 324 (FIG. 5B) located in the bottom cartridge plate 320. The connection between the scrubber 50 and the reservoir bag 60 (FIG. 1) may be via a self-sealing or one-way valve such that the recycle air exit 324 may be effectively sealed against the inflow of the surrounding ambient environment when the cartridge 30 is not attached to the reservoir bag interface 620 (FIG. 12). Additionally, the recycled air inlet 624 (FIG. 12) may also be sealed when a cartridge 30 is not attached to the reservoir bag interface 620. The various self-sealing and/or one-way valves may help to reduce potential contamination of the breathing device 100 (FIG. 1) system by a hazardous or toxic ambient environment.

The scrubber entrance 560 may be fluidly connected to a self-sealing valve. The self-sealing valve may be configured to open upon connection to an expiration tube 820 (FIG. 14), and close upon disconnection of the expiration tube 820. The self-sealing valve may prevent or inhibit the contamination of the breathing device 100 (FIG. 1) during a cartridge 30 swap, initial start up, or a storage period. The expiration tube 820 may have to be disconnected from the scrubber entrance 560 during an exchange of cartridges 30. The expiration tube 820 may be connected to the expiration orifice 234 and a one-way valve. The one-way valve of the expiration orifice 234 may be connected to a self-sealing valve of the scrubber entrance 560 of the scrubber 50 when the top housing 240 (FIG. 2) is closed, causing the self-sealing valve to open and enabling passage of expiration air from the expiration tube 820 to the scrubber entrance 560. Opening of the top housing 240 may disconnect the one-way valve of the expiration orifice 234 from the self-sealing valve of the scrubber entrance 560, closing the self-sealing valve. However, in certain embodiments, the expiration tube 820 may be directly connected to the scrubber 50 via a one-way valve to the self-sealing valve located at the scrubber entrance 560. In other embodiments, the expiration tube 820 may be connected to the scrubber entrance 560 via a one-way valve and the top cartridge plate 300.

The scrubber exit 580 in this illustrative embodiment is positioned beneath the scrubber chamber 500. The scrubber exit 580 may comprise a self-sealing or one-way valve that may be open when the cartridge 30 is connected to the reservoir interface plate 620 (FIG. 12), and may be closed when the cartridge 30 is not connected to the reservoir interface plate 620. The self-sealing or one-way valve may prevent or inhibit the influx of the ambient atmosphere into the scrubber chamber 500 during installation of a cartridge 30 or storage of a cartridge 30. The restriction of gas flow into the scrubber chamber 500 may reduce the potential contamination of the scrubber chamber 500 and allow for an extended storage life. However, scrubbed or recycled air may flow out through the scrubber exit 580 and into the reservoir bag 60 (FIG. 1) via the bottom cartridge plate 320 and the recycled air inlet 624 (FIG. 12) when the cartridge 30 is secured within the cartridge section 210 of the interior of a housing 20 (FIG. 2) and the scrubber 50 is actuated.

### Scrubber Membrane

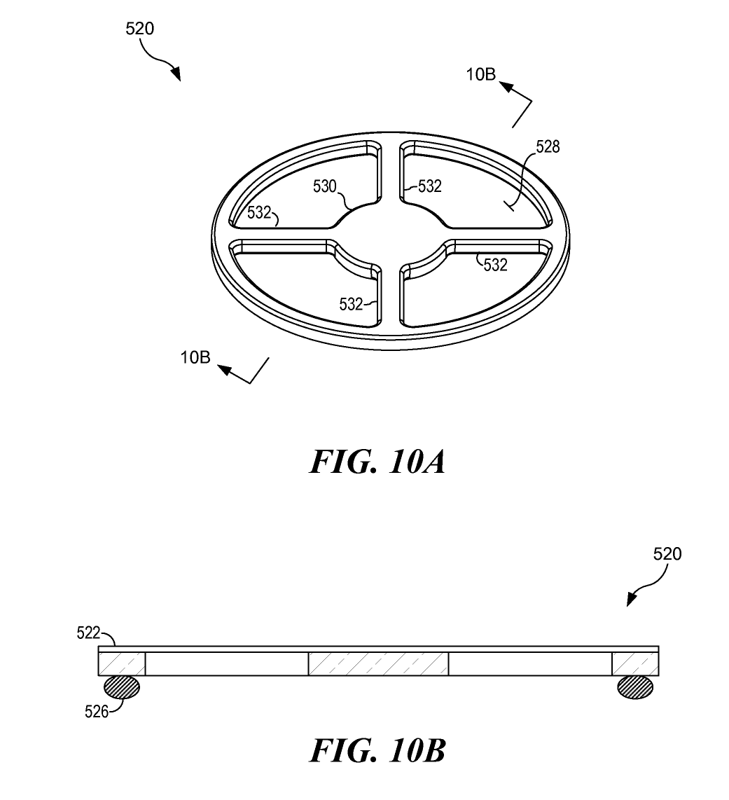

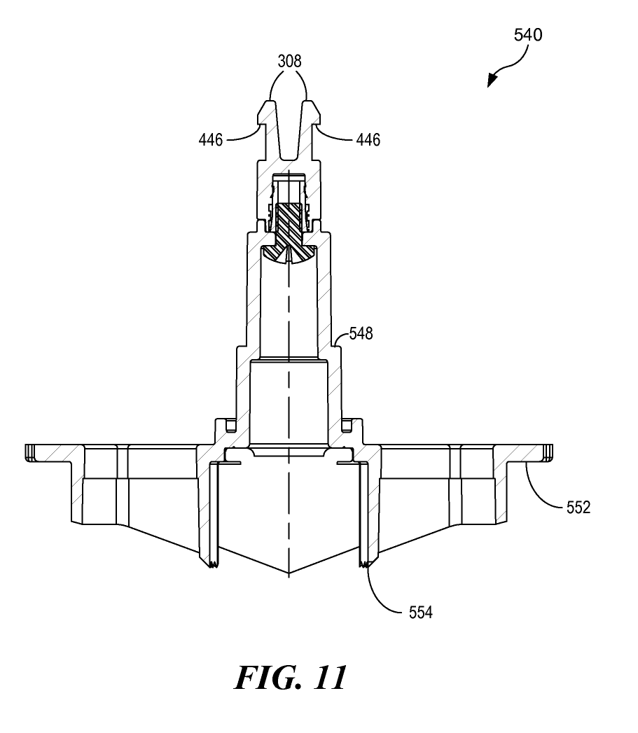

Prior to activation, the scrubber chamber 500 may restrict gas flowing in though the scrubber entrance 560 from being scrubbed via scrubbing chemicals by a scrubber membrane 520. Turning now to FIGS. 10A and 10B, the scrubber membrane 520 may be similar to the reaction membrane 420 (FIGS. 7A, 7B, and 7C). However, the scrubber membrane 520 may not comprise a storage compartment for a cup spinner 460 as in the oxygen source 40 (see FIG. 6). The scrubber membrane 520 may also be covered with a single scrubber membrane covering 522 made of a material impervious to the flow of a gas. Some embodiments of the scrubber membrane covering 522 may comprise a foil made of laminated materials such as aluminum, adhesive, an oxygen barrier, and a liquid barrier. Examples of these materials may comprise polyethylene (PE), polyethylene terephthalate (PET), and polyvinylchloride (PVC), among others. The use of the scrubber membrane 520 helps to maintain the scrubbing chemicals in an initial, un-reacted state. This may allow the scrubber 50 to be stored for an extended period of time. The scrubber membrane 520 may be breached or pierced by a scrubber plunger 540 upon actuation of the cartridge 30 (see FIG. 6).

A secondary seal 526, similar to the seal 426 of the reaction membrane 420 (see FIGS. 7B and 7C), may abut the mating surfaces of the scrubber membrane 520 and the shelf 502 (FIG. 6). The secondary seal 526 may be a resilient material such as a rubber o-ring for example. The secondary seal 526, along with the scrubber membrane covering 522, may help to hermetically seal the scrubber chemicals from reaction with the environment external to the cartridge 30.

The scrubber membrane 520 may comprise a substantially circular center guide 530. The center guide 530 may be supported by one or more support arms 532. The one or more support arms 532 may divide the openings around the center guide 530 of the scrubber membrane 520 into one or more of substantially pie-shaped scrubber openings 528. The scrubber membrane covering 522 may cover and seal the scrubber openings 528.

### Scrubber Plunger

Turning now to FIG. 11, the scrubber plunger 540 may be configured to be similar to the reaction plunger 440 of the oxygen source 40 (see FIG. 6). In this illustrative embodiment, the scrubber plunger 540 comprises activation tabs 308. The activation tabs 308 releasably secure the scrubber plunger 540 against the bias of a resilient member 554 (FIG. 6). As with the activation tabs 308 of the reaction plunger 440, the activation tabs 308 of the scrubber plunger 540 each comprise retention edges 446. The retention edges 446 may abut a reinforced area of the top surface of the top cartridge plate 300 (FIG. 6). The scrubber plunger 540 may be actuated by disengaging the retention edges 446 from the top surface of the top cartridge plate 300. Upon release of the activation tabs 308, the scrubber plunger 540 may be driven through the scrubber membrane 520 by the resilient member 554, piercing the scrubber membrane covering 522, and establishing a fluid passageway between the scrubber entrance 560 and the scrubber exit 580. However, many methods may be use to force the scrubber plunger 540 through the scrubber membrane 520. These methods may comprise mechanical and electro-mechanical devices, solenoids, levers, and pneumatic and hydraulic pressure, among others.

The scrubber plunger 540 may comprise a plurality of cutting edges 544. The plurality of cutting edges 544 may be configured around a substantially circular circumference able to slidingly accommodate the center guide 530 of the scrubber membrane 520 (see FIGS. 10A and 10B). The plurality of cutting edges 544 may be formed of an acetal resin engineering plastic, such as polyoxynethylene (POM), polytrioxane, and polyformaldehyde, among others. Delrin™ sold by Dupont is another type of acetal resin engineering plastic that may be used for the plurality of cutting edges. The Delrin™ or other lubricious material may be dissimilar to the material used for the scrubber membrane 520 and the top cartridge plate 300 (FIG. 6). The dissimilar materials may prevent sticking or welding of the materials during the assembly process or long term storage with applied forces.

As an example of an embodiment of the present invention, the plurality of cutting edges 544 may comprise an approximately pie shaped hollow projection extending below a scrubber plunger lip 552 and in some cases corresponding to the scrubber openings 528 (FIG. 10A). Although an approximately pie shaped hollow projection may be shown for the plurality of cutting edges 544, an embodiment of the scrubber plunger 540 may not be limited to this configuration. Any configuration and number of cutting edges capable of piercing the scrubber membrane covering 522 and establishing communication passageways between the lower chamber 510 and the upper chamber 505 may be used (see FIG. 6). The scrubber plunger lip 552 may be used to prevent the overextension of the scrubber plunger 540 beyond the shelf 502 of the scrubber chamber 500.

The resilient member 554 may be contained within a down tube 358 attached to the underside of the top cartridge plate 300 (see FIG. 6). The resilient member 554 may interact with the underside of the top cartridge plate 300 and a circumferential ledge 548 of the scrubber plunger 540. The down tube 358 may guide and/or center the scrubber plunger 540 within the scrubber chamber 500. The down tube 358 and the activation tabs 308 (FIG. 6) of the scrubber plunger 540 may facilitate the proper positioning of the scrubber plunger 540 in relation to the scrubber membrane 520 (FIG. 6) during storage, shipping, and activation. The center guide 530 of the scrubber membrane 520 (see FIGS. 10A and 10B) interacting with the substantially circular inner circumference of the plurality of cutting edges 544 may help to direct the scrubber plunger 540 during activation, and prevent and/or inhibit the scrubber plunger 540 from inadvertently contacting or binding against the scrubber member 520. The scrubber plunger 540 may be further aligned by one or more protruding guide rails located on the side walls of the scrubber chamber 500 (FIG. 6). The guide rails may slidably engage a corresponding notch, keyway, or indention located in the perimeter of the scrubber plunger 540.

### Reservoir Bag

Turning now to FIG. 12, a reservoir bag 60 of this illustrative embodiment of the present invention may comprise a reservoir interface plate 620, sealingly coupled to an opening of the reservoir container 600. The remaining perimeter of the reservoir container 600 may be hermetically sealed to prevent inadvertent or unintended inflows or outflows of gas. The reservoir container 600 may be formed from one or more pieces of material impervious to gas. Further, the reservoir container 600 defines an expandable volume able to accept inflows from the oxygen source 40, and recycled air from the scrubber 50 (see FIG. 6). One source of outflow from the reservoir container 600 is through the inhalation tube 800 (FIG. 14) via the inhalation tube outlet 660. Another source of outflow for the reservoir container 600 is through a pressure relief valve 640 when the reservoir container 600 reaches a limiting pressure level.

The material used for the reservoir container 600 may be relatively thin, lightweight, durable, and pliable. The reservoir container 600 may be made of various materials without limitation, for example, a latex-free neoprene among others. The material used for the reservoir container 600 may also be thermally conductive. This may enable the reservoir container 600 to lower the temperature of the catalytically produced oxygen and recycled air mixture prior to being delivered to the user via the inhalation tube outlet 660. Additionally, the reservoir bag 60 may comprise internal or external restraints configured to restrict or control the expansion of the reservoir container 600 to a desired shape and size. Examples of these restraints may comprise external belts, internal webbing, and directly connecting various sections of a first layer and a second layer of the reservoir bag (e.g., along joint line 680), among others.

The reservoir container 600 may be folded into the reservoir section 212 of the housing 20 for storage (see FIG. 2). Upon activation of the oxygen source 40 (FIG. 1), the reservoir container 600 of the reservoir bag 60 may be configured to expand as a result of the build up of pressure within the reservoir container 600. The reservoir bag 60 may comprise a pressure relief valve 640 in order to maintain the pressure within the reservoir container 600 at or below a safety level. The pressure relief valve 640 may be configured to release at least a portion of the contents of the reservoir container 600 into the surrounding environment in order to reduce the pressure level of the reservoir container 600. The safety level of pressure may be configured at a point below the rupture pressure of the material and/or the various seals of the reservoir bag 60. In addition, the safety level of pressure may further be configured below the rupture pressure of the various connections and fittings of the remaining components of the breathing device 100 (FIG. 1).

In certain embodiments, the filling of the reservoir bag 60 may cause the bottom housing 260 (FIG. 2) to open. Alternatively, the bottom housing 260 may fall open due to the effects of gravity after the removal of a storage clip 920 (FIG. 17). The reservoir bag 60 may then extend though the bottom opening of the housing 20 (FIG. 2), possibly due to the effects of gravity and the resilient nature of the folded material of the reservoir container 600. The reservoir bag 60 may initially be completely depressurized or subjected to a slight vacuum prior to assembly within the housing 20.

### Activation Mechanism

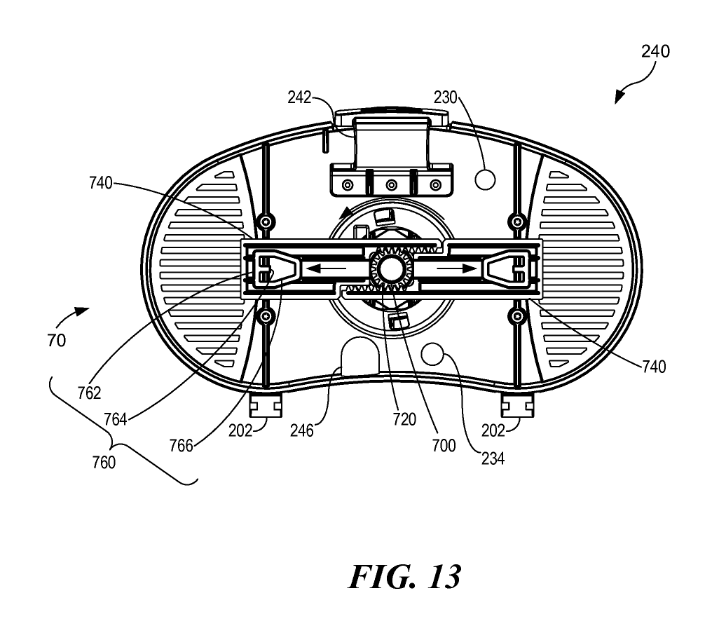

Certain embodiments of the present invention may comprise an activation mechanism 70. Turning now to FIG. 13, the activation mechanism 70 may comprise an actuator 700. An actuator 700, such as a knob for example, may be rotatably coupled to the top housing 240. The actuator 700 may further be resiliently coupled to a spring (not shown) so that the actuator 700 is biased in a direction opposed to actuation. In addition, the actuator 700 may be locked in place via an easily removable cotter pin (not shown) or other such device. By resiliently coupling the actuator 700, the occurrence of accidental activations may be reduced, while still enabling a user to easily actuate the breathing device 100 (FIG. 1).

The actuator 700 may be coupled with an activating gear 720. Rotation of the actuator 700 may correspondingly rotate the activating gear 720. The activating gear 720 may be translatingly coupled to one or more activating plates 740 (two are shown in this illustrative embodiment). Consequently, rotating the actuator 700 in the direction of the arrow may translate each of the individual activation plates 740 in their respective directions as indicated by their arrows, in this case, away from one another.

The activating plates 740 may each comprise an activating orifice 760. As shown in FIG. 13, each activating orifice 760 may comprise an approximately rectangular section 762 partially divided by a protrusion 764, and a narrowing wedging section 766. When the top housing 240 is closed upon an installed cartridge 30 (FIG. 1) by pivoting the top housing 240 about hinges 202, the activation tabs 308 (FIG. 6) may be inserted into the rectangular sections 762 of the activating orifices 760, on either side of the protrusions 764. Each protrusion 764 may maintain the activation tabs 308 in a separated state, coupled with the top cartridge plate 300 (FIG. 6), thereby inhibiting inadvertent or accidental activation of the cartridge 30.

Rotating the actuator 700 in this illustrative embodiment may cause the activating orifice 760 to translate with respect to the activating tabs 308 (FIG. 6). In such a case, the protrusion 764 may be withdrawn from between the activating tabs 308. The activating tabs 308 may then be slidably repositioned into the narrowing wedging section 766 of the activating orifice 760. The side walls of the narrowing wedging section 766 of the activating orifice 760 may force the activating tabs 308 closer to one another, thereby releasing the retention ledge 446 (FIGS. 9 and 11) of the activating tabs 308 from engagement with the top cartridge plate 300 (FIG. 6). Once released from the top cartridge plate 300, the plungers 440, 540 may penetrate through their respective membranes 420, 520, actuating the oxygen source 40 and the scrubber 50 of the cartridge 30 (see FIG. 6).

The illustrative embodiment of the present invention may use a rotating knob actuator 700 and activating plates 740 as an example of how to actuate a cartridge 30 (FIG. 6). However, many methods and mechanisms may be used to actuate a cartridge 30. Embodiments of the breathing device 100 (FIG. 1) may comprise levers, push buttons, electro-mechanical solenoids, and key mechanisms, among others. A simple activation process may be configured to enable a wide range of consumers to use the system in a medical or other applicable emergency. A simple activation process may also minimize the potential for improper use or mistake by users who may already be under tremendous amounts of psychological and physical stress as a result of an emergency situation. Other examples of activation mechanisms 70 and methods may be found in the Ross Catalytic Oxygen patent applications previously listed and incorporated herein by reference.

### Breathing Apparatus

Turning now to FIG. 14, the breathing device 100 (FIG. 1) may comprise an inhalation tube 800 and an expiration tube 820. The inhalation tube 800 and the expiration tube 820 may be fluidly coupled to a breathing apparatus 840. The various tubes (e.g., inhalation tube 800, expiration tube 820, and lower inhalation tube 802 (FIG. 2)) may be made of materials such as polyethylene, polypropylene, rubber, or neoprene, among others. The various tubes may also be corrugated or reinforced for additional strength and durability. The breathing apparatus 840 may comprise a breathing device 842 and a nasal passageway inhibitor 848 (e.g., a nose clip). The breathing device 842 may be placed in a sealed connection with the mouth of a user and may allow the user to breathe normally inward and outward. The inhalation tube 800 may be fluidly coupled with the breathing device 842 via a one-way valve 844. The one way valve 844 may provide a substantially unidirectional flow of oxygen and recycled air into the breathing apparatus 840. The expiration tube 820 may also be fluidly coupled with the breathing device 842 via a one-way valve 846. The one-way valve 846 may provide a substantially unidirectional flow of expired air out of the breathing apparatus 840 and into the expiration tube 820.

The nasal passageway inhibitor 848 may result in the user's mouth being the primary passageway for inhalation and exhalation. By blocking the nasal passageway and only permitting breathing to occur through the mouth via the breathing device 842, the user may be provided with a relatively safe supply of air while restricting unintended inhalation of a surrounding potentially toxic environment.

The expiration tube 820 may have a one-way valve at a distal end that allows expired air to exit via the distal end of the expiration tube 820. The one-way valve may result in a substantially unidirectional flow of expiration air out of the expiration tube 820 and may be used in addition to or in place of the one-way valve 846. The one-way valve may help to inhibit the flow of ambient atmosphere into a lower section of the expiration tube 820. During a cartridge swap, the expiration tube 820 may be disconnected from the cartridge 30 (FIG. 1). The one-way valve at the distal end of the expiration tube 820 may inhibit or prevent contamination by the atmosphere flowing into the distal end of the expiration tube 820. However, some embodiments of the present invention may comprise a expiration orifice 234 (FIG. 3) that comprises one-way valve. In such a case, the expiration tube 820 may remain connected to the expiration orifice 234 during a cartridge swap, and the expiration orifice 234 may then help to prevent contamination of the expiration tube 820.

The breathing apparatus 840 may be fluidly connected to the housing 20 of the breathing device 100 (FIG. 1) via the inhalation tube 800 and the expiration tube 820. The use of an inhalation tube 800 may enable further cooling of the inhalation air prior to the inhalation air reaching the user. The material used for the inhalation tube 800 and the expiration tube 820 may be thermally conductive, flexible, and removably attachable to connections proximate to the housing 20.

The breathing device 100 (FIG. 1) may further comprise attachment devices configured to secure the breathing device to a user. Examples of the many types of attachment devices that may be used comprise a belt 970, clip 960, and a shoulder strap 980, among others. Attachment devices may be configured to readily secure the breathing device 100 to the user. In addition, the attachment devices may be light weight to reduce an overall load for the user.

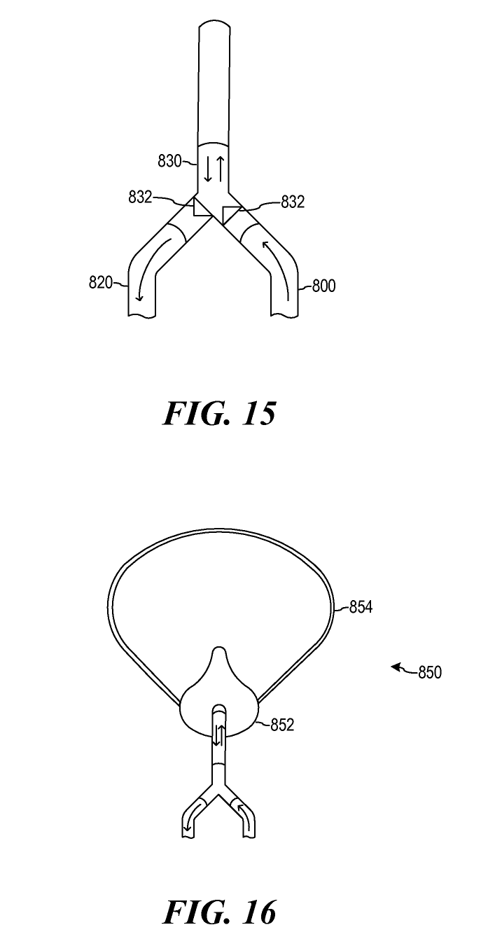

Turning now to FIG. 15, another embodiment of the present invention may comprise an inhalation tube 800 and an expiration tube 820 connected to a wye-connector 830 prior to being fluidly coupled with a breathing device 842 (FIG. 14). A bi-directional valve 832 may provide substantially the same functionality as the two one-way valves 844, 846 (see FIG. 14) of the previously described embodiment. Additionally, the bi-directional valve 832 may close off the expiration tube 820 and only allow oxygen and recycled air from the inhalation tube 800 into the breathing apparatus 840 during inhalation. Conversely, the bi-directional valve 832 may close off the inhalation tube 800 and only allow expired air to flow out of the breathing apparatus 840 and into the expiration tube 820 during exhalation. Use of the bi-directional valve 832 may result in substantially unidirectional fluid flow within the inhalation tube 800 and the expiration tube 820.

Alternatively, turning now to FIG. 16, certain embodiments of the present invention may comprise a breathing mask 850 as the breathing apparatus 840. The breathing mask 850 may comprise a face piece 852 and strap 854. The face piece 852 enables a user to breathe via their mouth and nose by sealing these passageways against inflows from the external environment. In some embodiments, the nasal passageway inhibitor 848 (FIG. 14) may be used with the breathing mask 850.

### Storage Cover

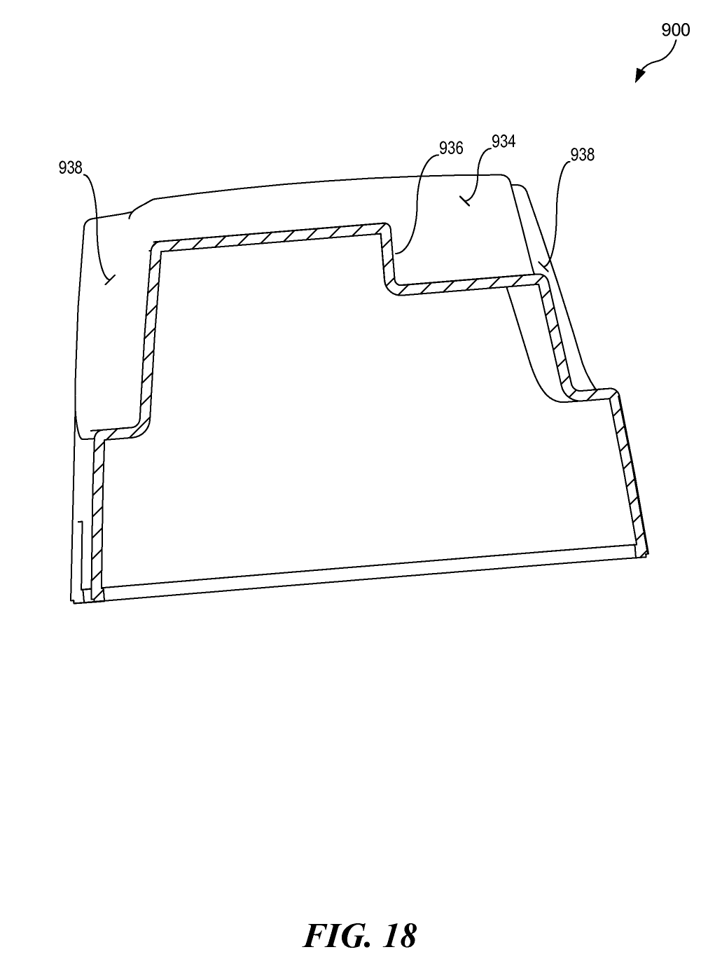

Turning now to FIGS. 17 and 18, a breathing device 100 of an embodiment of the present invention may have to be stored for an extended period of time prior to actual use. The conditions for storage may be hostile to the breathing device 100. Extreme temperatures, dirt, dust and debris, and a corrosive atmosphere may be present in the storage area. In order to protect the breathing device 100 during a storage period, the breathing device 100 may comprise a storage cover 900 and storage clip 920. The storage cover 900 may fit over the top housing 240 and provide some protection against the environment for the activation mechanism 70. The storage cover 900 may be made of polyvinylchloride (PVC), or polyethylene terephthalate (PET), among others. The storage cover 900 may be made of a material similar to the housing 20 or the storage cover 900 may be made of a different material.

The storage cover 900 may be snap fitted to the top housing 240 or may rest upon the top housing 240 for example. The storage cover 900 may be removably secured to the top housing 240 via a storage clip 920 or other fastening device, such as, fasteners, straps, clasps, interlocking features, among others. The interior of the storage cover 900 may be configured to secure the breathing apparatus 840, inhalation tube 800, and expiration tube 820. Additionally, the storage cover 900 may be made of a transparent material to allow easy identification of the breathing apparatus 840 and/or the other components stored within the storage cover 900. The storage cover 900 may have cover indentions 938 or concavities to facilitate the grasping and removal of the storage cover 900 by a hand of a user. Two cover indentions 938 are shown as examples in this illustrative embodiment. Undercut features may be incorporated into the cover indentations 938 to removably secure the breathing apparatus 840. Certain embodiments of the present invention using a face mask 852 may place the face mask 852 (FIG. 16) within the storage cover 900 at a location coinciding with the actuator 700 (FIG. 3) for additional protection of the actuator 700.

The storage cover 900 may comprise a storage cover clip channel 932 defined between opposing storage cover walls 934. The storage cover clip channel 932 may be lower in height than the surrounding surfaces of the storage cover 900 so as to prevent inadvertent or accidental movement of the storage clip 920 in a longitudinal direction of the storage cover 900. The storage cover clip channel 932 may further comprise a storage cover clip retention ledge 936 (shown in FIG. 18) to abut and temporarily retain a corresponding upper clip retention ledge 924 of the storage clip 920 in a transverse direction of the storage cover 900. An example of a cross-section of a configuration of the storage cover clip channel 932 may be seen in FIG. 18. Although a relatively straight storage cover clip retention ledge 936 may be shown in FIGS. 17 and 18, many different configurations may be employed to temporarily retain a storage clip 920 in the transverse and longitudinal directions of the storage cover 900. For example, a circular orifice in one of the storage clip 920 and the storage cover 900 and a corresponding cylindrical protrusion in the other of the storage clip 920 and the storage cover 900 may be used, among others.

### Storage Clip

The storage clip 920 may be made of an appropriately resilient material able to provide a slight compressive force to the storage cover 900 and the bottom housing 260. The storage clip 920 may be made of stainless steel, aluminum, and polypropylene, among others. The storage clip 920 may be used to hold the bottom housing 260 proximate to the lower end of the housing 20. The storage clip 920 may comprise an upper clip retention ledge 924 and a lower clip retention ledge 922. The upper clip retention ledge 924 may engage with a storage cover clip retention ledge 936 (FIG. 18), inhibiting the transverse movement of the storage clip 920. The lower clip retention ledge 922 may engage with the bottom housing clip retention ledge 266 (FIGS. 4A and 4B). Although a storage clip 920 is shown as an example of a storage device able to temporarily secure the storage cover 900 and the bottom housing 260, many other such storage devices may be considered, such as belts, wraps, straps, and snap-fits, among others. Removal of the storage clip 920 from the rest of the breathing device 100 may involve resiliently moving one or both of the upper clip retention ledge 924 and the lower clip retention ledge 922 away from the respective storage cover clip channel 932 and the bottom housing clip channel 262 (FIGS. 4A and 4B). One or both of the upper clip retention ledge 924 and the lower clip retention ledge 922 may respectively disengage from the storage cover clip retention ledge 936 and the bottom housing clip retention ledge 266. The storage clip 920 may then be pulled away from the rest of the breathing device 100.

### Anti-Activation Devices

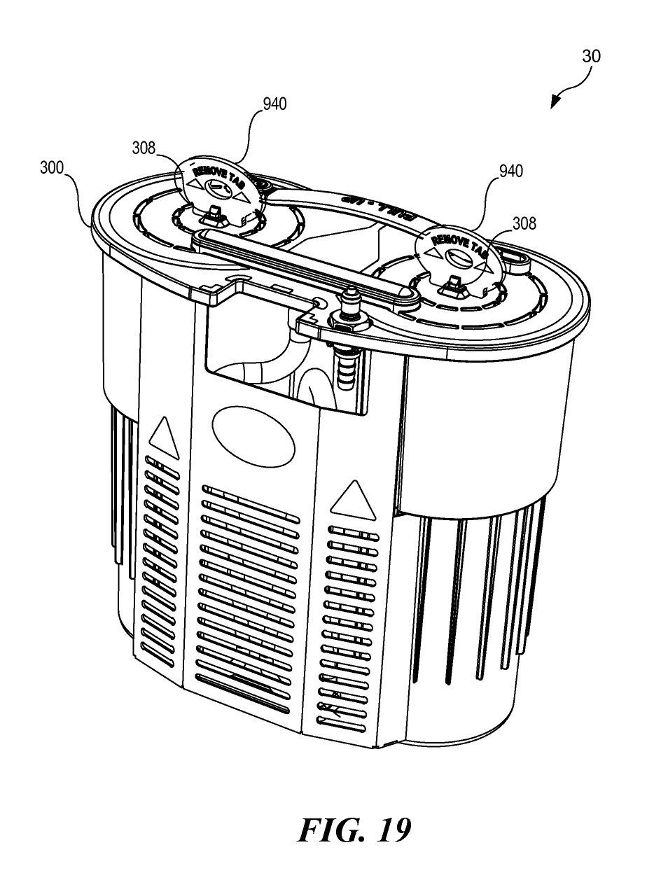

Turning now to FIG. 19, the cartridge 30 may additionally comprise anti-activation devices 940. The anti-activation devices 940 may be inserted between the activation tabs 308 to prevent or inhibit inadvertent actuation of the cartridge 30 while a cartridge 30 is stored outside of a housing 20. In some embodiments of the present invention, the anti-activation devices 940 are shown as storage keys. The anti-activation devices 940 may prevent inadvertent contact or motion resulting in the release of the activation tabs 308. In the example shown, the anti-activation devices 940 may be placed between the activation tabs thereby maintaining the engagement between the activation tabs 308 and the top cartridge plate 300.

### Utilization

Returning to FIG. 17, a user faced with a potentially hazardous situation may use a SCSR breathing device 100 as follows. Upon notice of an emergency, the user may remove the breathing device 100 from the storage area. The storage clip 920 may be removed. Removal of the storage clip 920 from the rest of the breathing device 100 may involve resiliently moving one or both of the upper clip retention ledge 924 and the lower clip retention ledge 922 away from the respective storage cover clip channel 932 and the bottom housing clip channel 262 (FIGS. 4A and 4B). One or both of the upper clip retention ledge 924 and the lower clip retention ledge 922 may respectively disengage from the storage cover clip retention ledge 936 and the bottom housing clip retention ledge 266 (FIGS. 4A and 4B). The storage clip 920 may then be pulled away from the rest of the breathing device 100. The storage cover 900 may be removed. The user may determine if a cartridge 30 is present within the housing 20 by opening the top housing 240 for example. Typically, to shorten the time required to initially prepare a breathing device 100 in the event of an emergency, a cartridge 30 may be stored within the housing 20 during the storage period. If a cartridge 30 is not present within the housing 20, a cartridge 30 may then selected from a storage area, the anti-activation devices 940 (FIG. 18) may be removed, and the cartridge 30 may be installed within the housing 20.

The cartridge 30 may be inserted within the housing 20 until the top cartridge plate 300 (FIGS. 5A and 5B) abuts a corresponding lip of the upper edge of the housing 20. At this point, the various connections between the bottom cartridge plate 320 (FIG. 5B) and the reservoir interface plate 620 (FIG. 12) may be established. The top housing 240 may then be closed over the top of the cartridge 30, engaging the activation mechanism 70 (FIG. 1) with the activation tabs 308 (FIG. 19).

The user may connect the inhalation tube 800 and the expiration tube 820 to the top of the lower inhalation tube 802 (FIG. 2) and the expiration orifice 234 (FIG. 3) respectively. The user may actuate the activation mechanism 70 by turning the actuator 700 (FIG. 3). As a result, the catalytic production of oxygen by the oxygen source 40 may be commenced and access to the scrubber 50 may be established for expiration air (see FIG. 1). In certain embodiments, the user may check the operational status of the breathing device 100 by observing the function indicator 306 (FIG. 5A) via the function indicator orifice 230 (FIG. 3) and/or observing the reservoir bag 60 (FIG. 12) for pressure build-up.

The user may apply the breathing apparatus 840 to their mouth and nose and commence with the inhalation of generated oxygen. The breathing device 100 may be self initiating in which the breathing device 100 may not require an initial expiration from the user prior to the user inhaling from the system. After inhalation, the user may continue to breathe normally. Expirations may be scrubbed of excess CO₂ by the scrubber 50 (FIG. 1) and delivered to the reservoir bag 60 (FIG. 12). The oxygen source 40 (FIG. 1) may continue to generate and deliver oxygen to the reservoir bag 60. The mixture of oxygen and recycled expiration air may be inhaled by the user. A circuit closed to inflow from the surrounding environment may be configured as follows:
1. A user exhales expiration air via the breathing apparatus 840 and the expiration tube 820 into the scrubber 50 (FIG. 1);
2. The scrubber 50 removes excess CO₂ and exits recycled air into the reservoir bag 60 (see FIG. 12);
3. The recycled air in the reservoir bag 60 is mixed with generated oxygen from the oxygen source 40 (see FIG. 1);
4. The mixture of recycled air and generated oxygen from the reservoir bag 60 (FIG. 12) is inhaled by the user through the inhalation tube 800 and breathing apparatus 840, thereby completing the circuit.

### Cartridge Swapping

There may be situations during a single emergency in which a user may want to replace a current cartridge 30 with another cartridge 30. This process may take place while the user continues to inhale breathable air from the reservoir bag 60 (FIG. 12) via the inhalation tube 800 and exhale expiration air through the expiration tube 820. The replacement may be indicated by the function indicator 306 (FIG. 5A) or by some other parameter such as time period of use for the current cartridge 30.

To replace a cartridge 30 during the course of an emergency, the user may pivot the top housing 240 open to enable access to the interior of the housing 20. The inhalation tube 800 may remain connected to the lower inhalation tube 802 and the user may continue to breathe from the inhalation mixture remaining in the reservoir bag 60 (FIG. 12). A distal end of the expiration tube 820 may comprise a one-way valve, enabling the user to exhale expiration air into the atmosphere while inhibiting the entry of ambient atmosphere into expiration tube 820. In the illustrative embodiment, the one-way valve may be incorporated into the expiration orifice 234 (FIG. 3) of the top housing 240. Opening the top housing 240 may disconnect the one-way valve of the expiration orifice 234 from a self-sealing valve located at the scrubber entrance 560 (FIG. 6). The scrubber entrance 560 may be closed but the user may still exhale through the expiration tube 820 via the expiration orifice 234 and the one-way valve.

The user may grasp the cartridge handle 310 (FIG. 5A) on the top of the cartridge 30. The cartridge 30 may be removed by pulling upward on the cartridge handle 310. As the cartridge 30 is removed from the housing 20, the connections between the expired cartridge 30 and the reservoir interface plate 620 (FIG. 12) may be severed and sealed, preventing contamination of the remaining inhalation air supply by the surrounding environment.

A new cartridge 30 may be obtained from storage and the anti-activation devices 940 (FIG. 19) removed. The new cartridge 30 may be installed within the housing 20. The top housing 240 may be closed and the activation device 70 (FIG. 1) actuated. Closing the top housing 240 may reconnect the one-way valve at the expiration orifice 234 (FIG. 3) with the self-sealing valve located at the scrubber entrance 560. The connection between the one-way valve located at the expiration orifice 234 and the self-sealing valve located at the scrubber entrance 560 (FIG. 6) may open the normally closed self-sealing valve. The expiration air may then flow through the scrubber 50. The entire process may occur without exposing the user to the potentially harmful atmosphere surrounding them. Additionally, the process may allow the user to continue breathing normally during the cartridge swapping procedure for as long as an inhalation air mixture exists in the reservoir bag 60 (FIG. 12).

The reusable components of this embodiment may primarily comprise the housing 20 along with the activation mechanism 70 (FIG. 1) and the cartridge seating system disposed within the housing 20. The disposable components of this embodiment may primarily comprise single use, disposable cartridges 30, or extension units. In this case, a single use refers to one single use for the rated duration of the cartridge 30 or extension unit. After that single use, the cartridge 30 may not be reused. There may be certain “single emergency” items, such as the inhalation tube 800, expiration tube 820, breathing apparatus 840, and the reservoir bag 60 (FIG. 12). A single emergency may involve a number of single use cartridges 30 used by the same user over the course of one emergency (e.g., during an emergency egress from a mine). After the emergency, it may not be advisable to place the breather apparatus 840 and reservoir bag 60 back into storage for further service, due to sanitary considerations. However, some single emergency items may be subjected to sterilization or sanitization and then be re-used depending upon the situation of the users.

### Further Embodiment

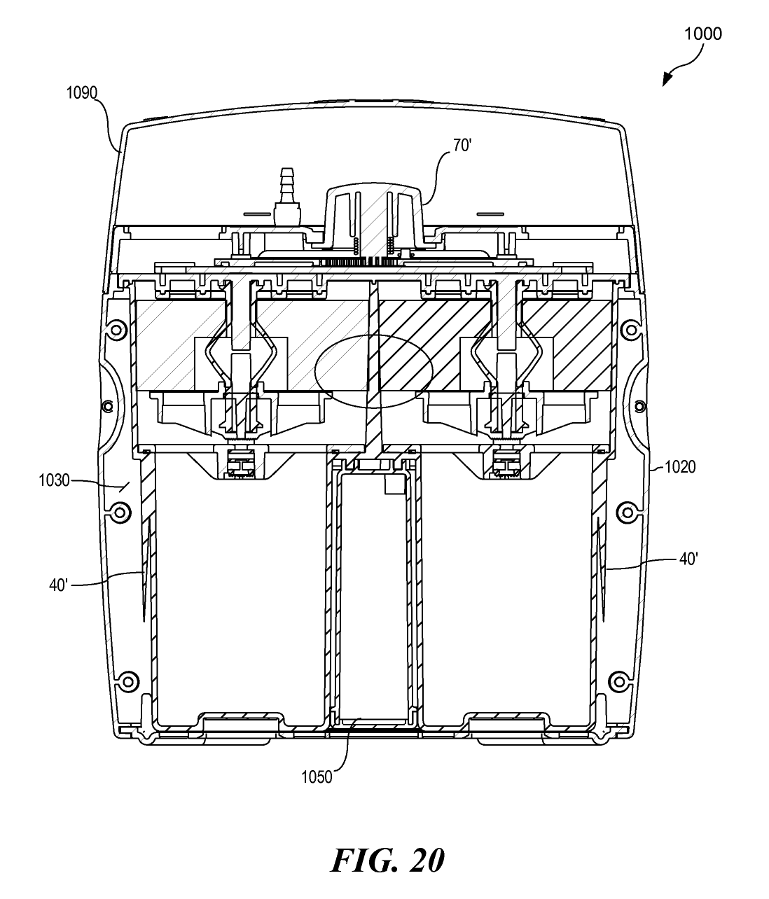

Turning now to FIG. 20, reference numeral 1000 generally indicates a further embodiment of a breathing device 1000 of the present invention. The breathing device 1000 may comprise one or more oxygen sources 40′ located within a cartridge 1030 in place of the oxygen source 40 and scrubber 50 (FIG. 1) combination of a previously detailed embodiment. The cartridge 1030 may be placed within a housing 1020. The cartridge 1030 may be activated by an activation mechanism 70′. An illustrative embodiment of a breathing device 1000 may further comprise a water trap 1050. In addition, a breathing device 1000 may comprise a storage cover 1090 to shield the activation mechanism 70′ during periods of storage. Components indicated by a prime mark ‘may have been described with regard to a previous embodiment of the present invention and the descriptions of these components may not be repeated.

### Housing

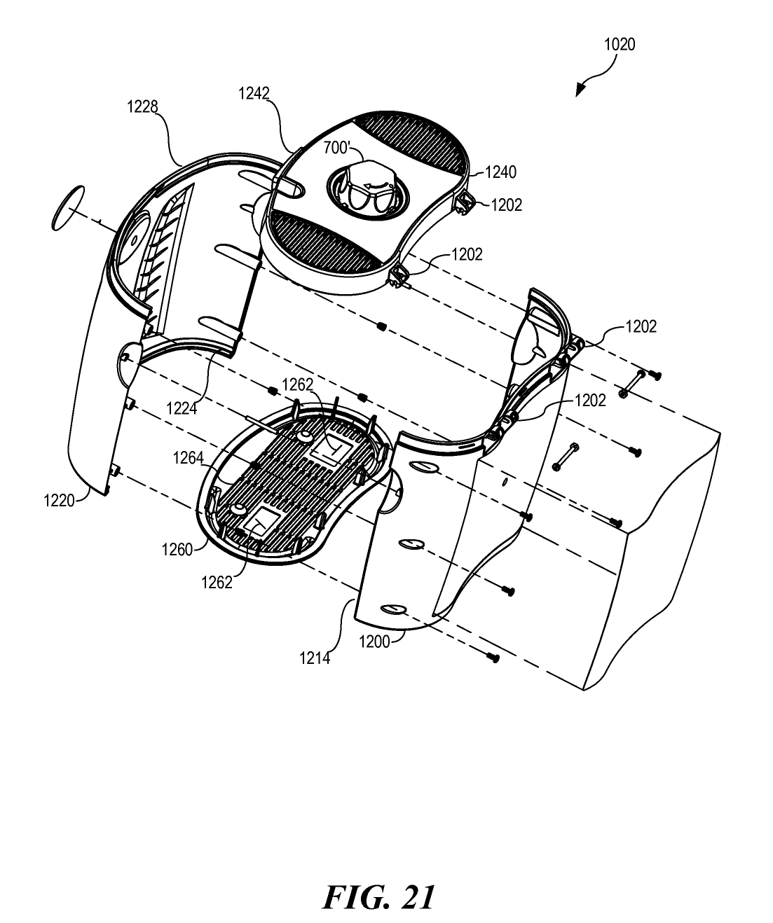

Turning now to FIG. 21, the housing 1020 of breathing device 1000 (FIG. 20) may comprise a rear housing 1200, a front housing 1220, a top housing 1240, and a bottom housing 1260. The various housing components may be made of material suitable for exposure to hazardous and/or toxic environments. In addition, the material may be configured to withstand long term storage without deterioration or breakage. The breathing device 1000 may be configured to be easily carried by a user, therefore, the material should be lightweight in addition to providing appropriate levels of strength. Additionally, the catalytic production of oxygen may release heat via an exothermic reaction. As a result, the material should be able to radiate and/or dissipate heat as well as insulate the user from harmful or excessive exposure to high temperatures. Some examples of material for the housing 1020 comprise acrylonitrile butadiene styrene (ABS) and polycarbonate/ABS alloy, polyvinylchloride (PVC), polystyrene (PS), and acrylic-polymethyl methacrylate (PMMA), among others. Additionally, several resin systems such as fluoropolymers including PTFE (trade name Teflon® sold by DuPont), acetal (polyoxymethylene), liquid crystal polymers (LCP), nylon, polyetheretherkeytone (PEEK), high-density polyethylene (HDPE), polyurethane (PU), polypropylene, and some thermosetting resins including epoxies, polyimides, and urethanes, among others. Further, metals including aluminum, stainless steel, and magnesium alloys, in addition to engineered materials including carbon fiber, among others, may also be used for the housing 1020. The materials described are intended as illustrative examples only, and are not considered to form an exhaustive list. Other materials may be used in addition to or in place of the materials previously discussed.

### Rear Housing

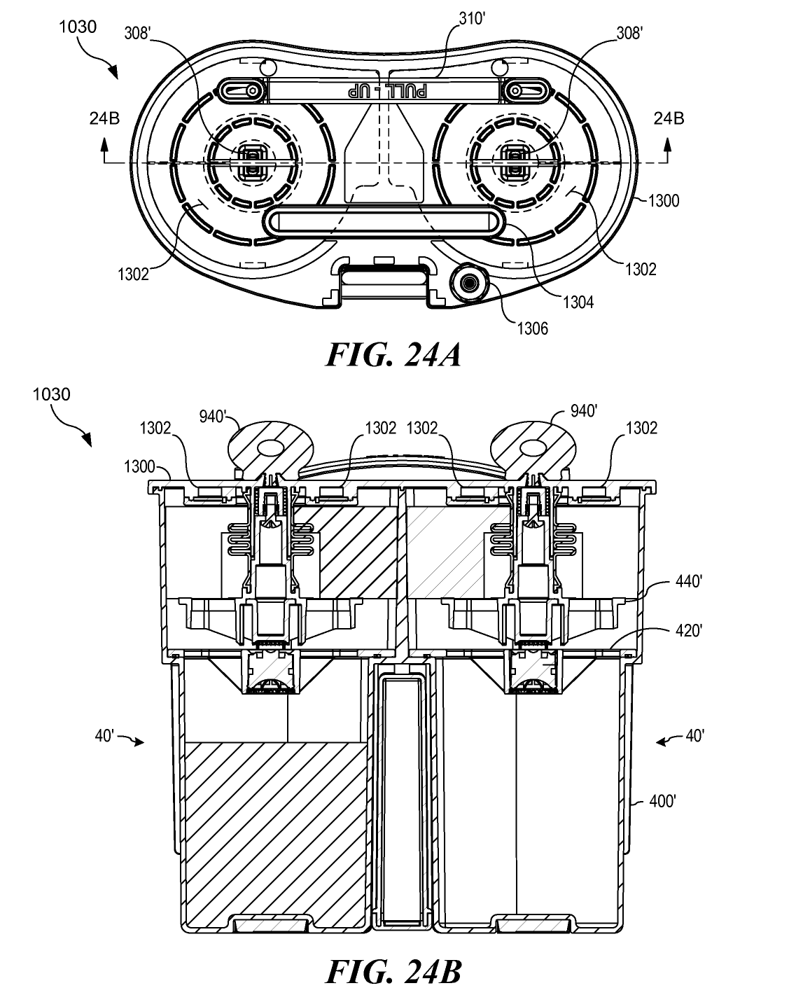

The rear housing 1200 of this illustrative embodiment may be hingedly coupled to the top housing 1240 and coupled to the bottom housing 1260. The rear housing 1200 may be substantially concave and designed to accommodate the rear of a cartridge 1030 (FIG. 1), described later. An upper ledge of the rear housing 1200, proximate to the top housing 1240, may correspond to a top cartridge plate 1300 (shown in FIG. 24A) of the cartridge 1030. The concavity of the rear housing 1200 may partially define an interior of an assembled housing 1020. This interior may be configured to slidingly accommodate the insertion and removal of the cartridge 1030 into and out of an assembled housing 1020.

The rear housing 1200 may be coupled to the bottom housing 1260 via a protruding bottom housing support 1214 (refer to the bottom housing support 1224 of the front housing 1220 for illustration). As an example, the bottom housing support 1214 may be in the form of a channel, shelf, groove, or substantially form a U-shape when viewed in cross-section. The bottom housing support 1214 may be configured to removably fix the bottom housing 1260, described later, with regard to the rear housing 1200. Additionally, the coupling between the bottom housing support 1214 and the bottom housing 1260 may be configured so that the bottom housing 1260 may be removable, allowing the housing 1020 to be repaired in case of damage to components of the housing 1020. In the illustrative embodiment shown in FIG. 21, the bottom housing 1260 may slide into engagement with the bottom housing support 1214 in a direction substantially perpendicular to the general plane of an interior surface of the rear housing 1200.

The bottom housing support 1214 may be represented in this exemplary embodiment as a substantially continuous element extending across the entire interior surface of the rear housing 1200. However, the bottom housing support 1214 should not be limited by this example. The bottom housing support 1214 may be formed of one or more discontinuous segments across a portion of the interior surface of the rear housing 1200.

Although a channel shaped protrusion may be shown for the bottom housing support 1214 in FIG. 21, embodiments of the present invention should not be limited to this single configuration. Tabs, protrusions, grooves, and interlocking contours may be examples of some of the other configurations for removably fixing the bottom housing 1260 to the rear housing 1200. Alternatively, an embodiment may be configured so as to permanently fix the bottom housing 1260 to the rear housing 1200 through the use of chemical adhesives or material welding for example. Further, a separate bottom housing 1260 may be shown as an example of an embodiment of the present invention. However, the bottom housing 1260 may be integrally formed from one or more of the components of the housing 1020.

The rear side of the rear housing 1200 may comprise features to enable the breathing device 1000 (FIG. 20) to be easily attachable to a user. Examples such as spring loaded clips 960, belts 970, and shoulder straps 980, among others, are readily adaptable to the rear of the rear housing 1200 or to the housing 1020 in general (see FIG. 14 of an earlier embodiment). Potential design considerations for attachment devices may include both speed of attachment and ease of attachment, in addition to reliability and strength.

### Front Housing

The front housing 1220 of this illustrative embodiment may be largely symmetrical to the rear housing 1200 and configured to accommodate the removable cartridge 1030. As such, the front housing 1220 may be substantially convex when viewed from the front. In addition, an upper ledge of the front housing 1220 proximate to the top housing 1240 may substantially correspond to a top cartridge plate 1300 (FIG. 24A) of the cartridge 1030. The front housing 1220 may be removably joined or secured to the rear housing 1200 through the use of screws, snap fits, belts, clasps, and interlocking features, among others. The front housing 1220 may be removable in order to facilitate the repair or replacement of various components of the breathing device 1000 (FIG. 20). Alternatively, the front housing 1220 may be permanently secured to the rear housing 1200 in certain embodiments. The methods of permanently securing the front housing 1220 to the rear housing 1200 may comprise chemical adhesive, rivets, and welding, among others.

The front housing 1220 may also comprise a bottom housing support 1224. The configuration of the bottom housing support 1224 of the front housing 1220 may correspond to the configuration of the bottom housing support 1214 of the rear housing 1200. Similar to the bottom housing support 1214, the bottom housing support 1224 may be configured to removably fix the bottom housing 1260 in position relative to the front housing 1220. Alternatively, the bottom housing 1260 may be permanently secured to the bottom housing support 1224.

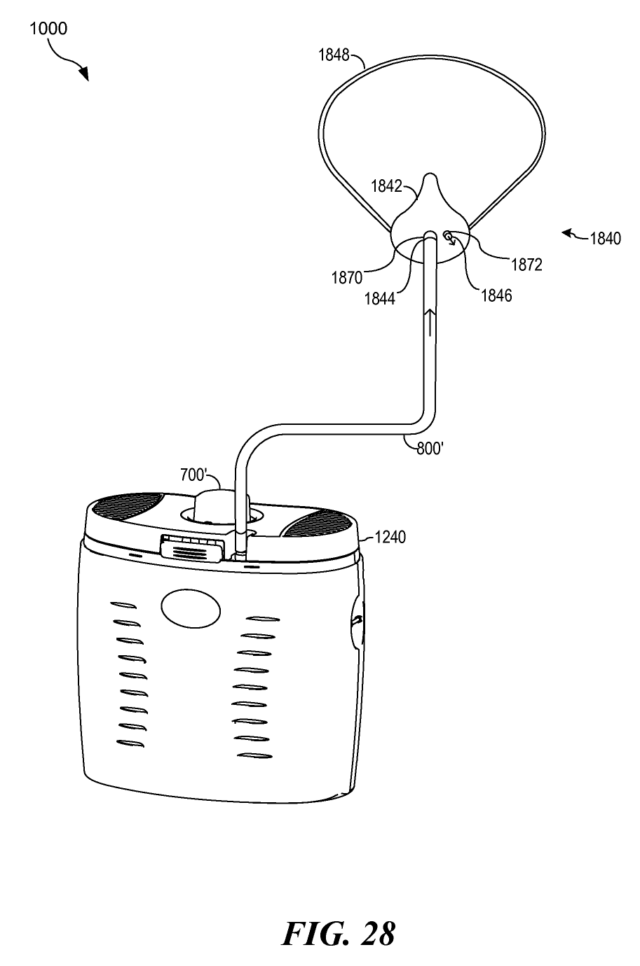

The front housing 1220 may comprise temperature control devices 1228, shown in FIG. 21 as a plurality of through openings, for example, slots. The temperature control devices 1228 may enable air to flow through the interior of the housing 1020 so as to convectively reduce the temperature of the interior. The temperature control devices 1228 may take many active and/or passive forms, including, but not limited to, louvers, fins, thermally conductive material, endothermic reactions, and powered fans and cold plates. The temperature control devices 1228 of this embodiment may be directed through the front of the front housing 1220, enabling the heat to travel away from a user wearing the breathing device 1000 (FIG. 20) in a conventional manner. In addition to reducing the temperature of the interior of the housing 1020, the temperature control devices 1228 may also aid in controlling the temperature of the inhalation gases through the inhalation tube 800′ (shown in FIG. 28).

### Top Housing

The top housing 1240 may be hingedly connected to the rear housing 1200 or the front housing 1220 via one or more hinges 1202. Additionally, the top housing 1240 may be hingedly connected via a flexible membrane, living hinge, or otherwise pivotal device, among others. As an example, an illustrative embodiment of the present invention shown in FIG. 21 illustrates the top housing 1240 as being hingedly coupled with the rear housing 1200 via two hinges 1202.

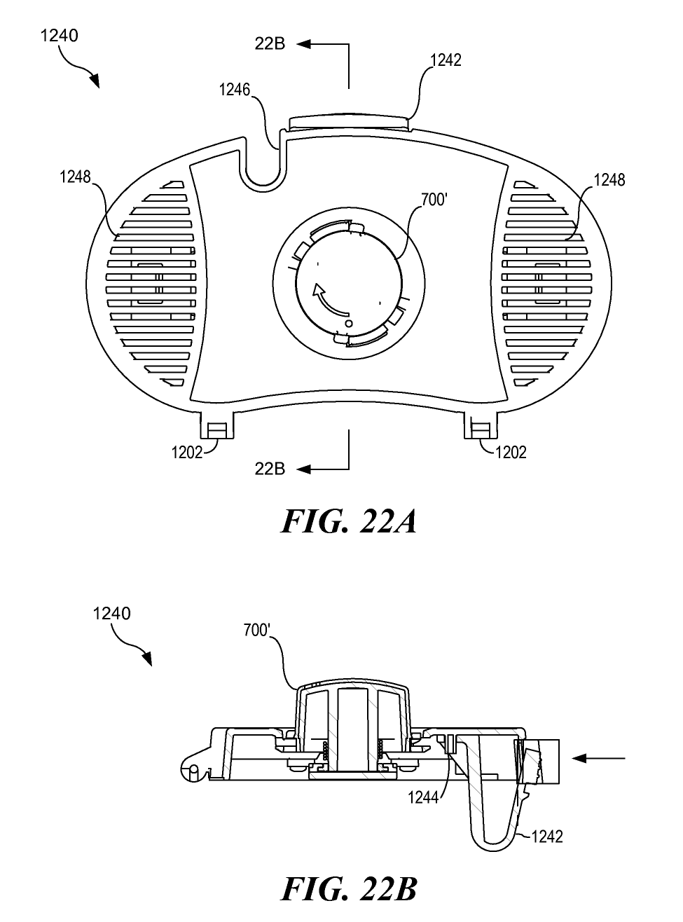

The top housing 1240 may be configured to openly close off the top of the interior of the housing 1020. The top housing 1240 may comprise a substantially U-shaped tab 1242 (also see FIG. 22B) located proximate to an edge of the top housing 1240 opposite of the hinged connection. The tab 1242 may be used to temporarily secure the top housing 1240 in a position covering the interior of the housing 1020. The tab 1242 may comprise nylon, for example. However, the tab 1242 may be made from other types of resilient materials. Further, protruding from the top housing 1240 may be one or more locating post 1244 (shown in FIG. 22B) for the tab 1242. The locating post 1244 may be perpendicularly located relative to the direction of the force applied by the tab 1242, shown in the direction of the arrow in FIG. 22B. The force applied by the tab 1242 may be substantially within a plane comprising the top housing 1240. The top housing 1240 may be pivotally opened in order to provide access to the interior of the housing 1020 for the replacement/installation of a cartridge 1030 (FIG. 1) and/or to facilitate the joining of various connections. Alternatively, instead of hingedly connecting the top housing 1240 to the rear housing 1200, in some other embodiments the top housing 1240 may be removably secured to the front housing 1220 and the rear housing 1200 through the use of snap fits, clasps, fasteners, straps, and clips, among others. The top housing 1240, in addition to the front housing 1220, rear housing 1200, and the bottom housing 1260, define the interior of the housing 1020.

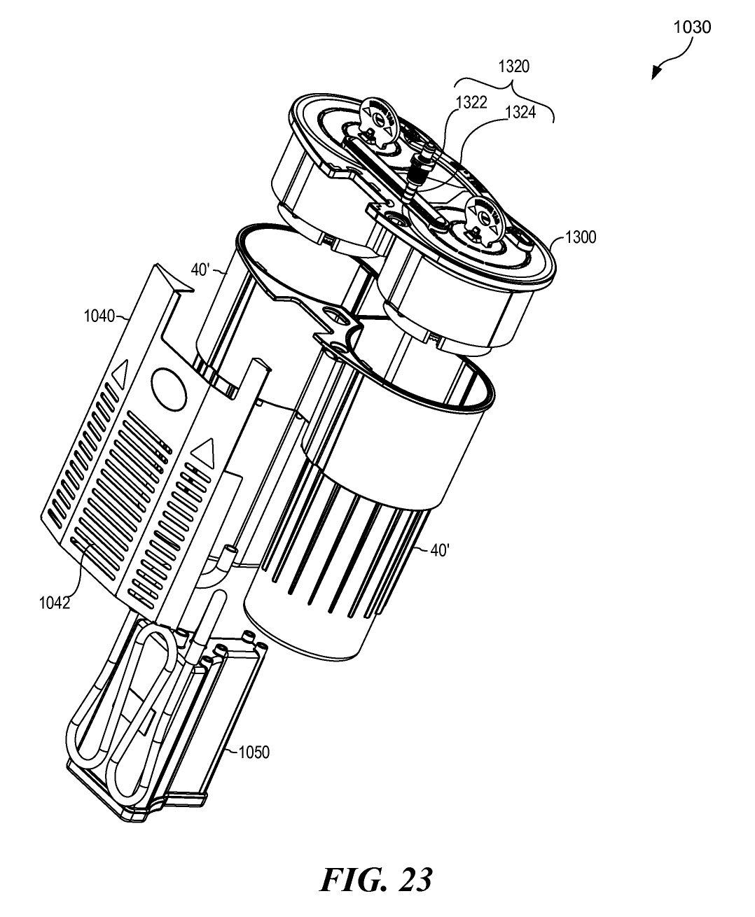

Turning now to FIG. 22A, the top housing 1240 may comprise accommodation for the inhalation tube 800′ (shown in FIG. 28). An example of an accommodation for the inhalation tube 800′ may be a substantially U-shaped housing tube notch 1246, configured to accommodate the outer diameter of the inhalation tube 800′ and/or the self-sealing connector 1320 (shown in FIG. 23). This housing tube notch 1246 may allow the top housing 1240 to be manipulated (i.e., opened and closed) without requiring the disconnection of the inhalation tube 800′. Although a substantially U-shaped housing tube notch 1246 is shown, embodiments of the present invention are not limited to this specific configuration. Any shape or design may be used as long as the top housing 1240 may be opened without requiring the disconnection of the inhalation tubes 800′ from the self-sealing connector 1320.

The top housing 1240 may comprise an actuator 700′, such as a knob for example, rotatably extending through the top housing 1240. The actuator 700′ may enable a user to externally actuate a cartridge 1030 located within the housing 1020 (see FIG. 20). The actuator 700′ may be rotated in the direction of the arrow to activate the cartridge 1030. Additionally, the actuator 700′ may comprise a resilient member (not shown) interacting with the actuator 700′ and the top housing 1240 so as to apply a reverse bias in a direction opposite to the arrow. The reverse bias of the actuator 700′ may inhibit or reduce inadvertent or accidental activations of a cartridge 1030 through inadvertent striking, dropping, or contact with the actuator 700′.

The top housing 1240 may comprise temperature control devices 1248, shown in FIG. 22A as a plurality of through openings, for example, slots. The temperature control devices 1248 may enable air flow through the interior of the housing 1020 in order to aid in reducing or cooling the temperature of the interior. The temperature control devices 1248 may take many active and/or passive forms, including, but not limited to, louvers, fins, thermally conductive material, endothermic reactions, phase change materials, and powered fans.

### Bottom Housing

Returning to FIG. 21, the bottom housing 1260 may be coupled to the front housing 1220 and the rear housing 1200. In this illustrative embodiment, the bottom housing 1260 is shown as being securely coupled between an assembled front housing 1220 and rear housing 1200 via the bottom housing support 1224 of the front housing 1220 and the bottom housing support 1214 of the rear housing 1200. The bottom housing 1260 may be configured to close off the lower end of the housing 1020. In other embodiments, the bottom housing 1260 may be permanently attached to the front housing 1220 and/or the rear housing 1200. Alternatively, the bottom housing 1260 may be integrally formed from one or more of the other components of the housing 1020.

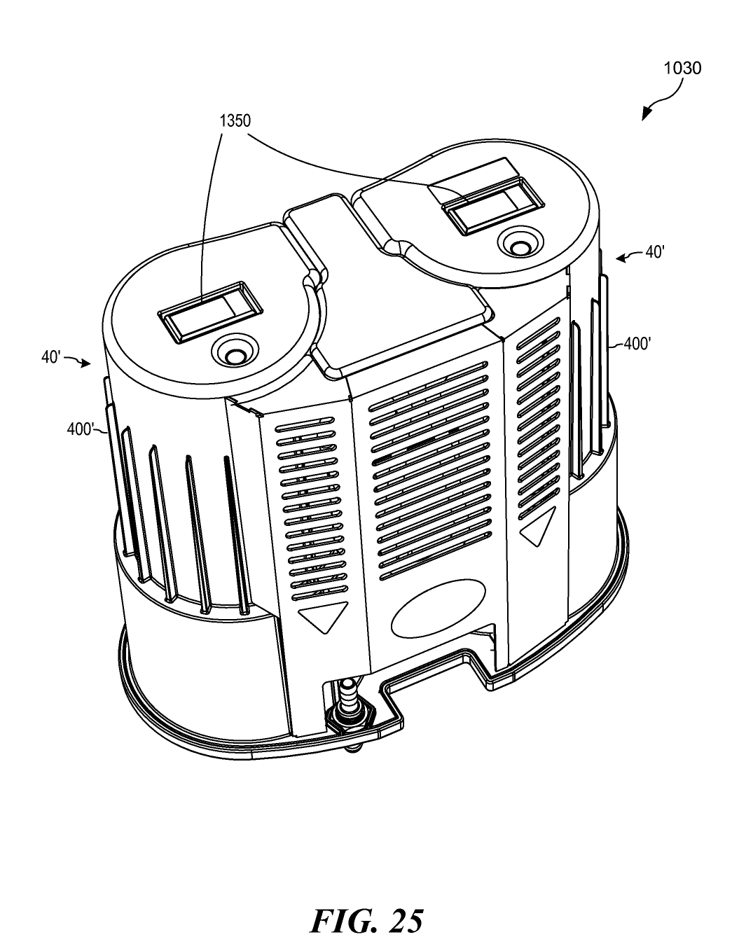

The bottom housing 1260 may comprise one or more function indicating orifices 1262. As shown for this illustrative embodiment, two function indicating orifices 1262 may be positioned within the bottom housing 1260. When a cartridge 1030 (FIG. 1) is assembled within the housing 1020, the function indicating orifices 1262 may each be coincident with a temperature indicator 1350 located proximate to the bottom of each of the oxygen sources 40′ (see FIG. 25). When a cartridge 1030 is actuated, the approximate temperature of the reaction chamber 400′ (shown in FIG. 25) of the oxygen source 40′ may be indicated via a color changing temperature indicator 1350. This may allow a user to approximately determine both the functioning of each oxygen source 40′ (e.g., a functioning oxygen sources 40′ may experience a rise in temperature relative to the ambient conditions), and the relative degree of safety for handling an actuated cartridge 1030 (e.g., when replacing an expired cartridge 1030 with a new cartridge 1030, the temperature indicator 1350 may indicate whether the cartridge 1030 may be safely handled by users).

The bottom housing 1260 may further comprise temperature control devices 1264, shown in this embodiment as a plurality of orifices (e.g., slots). The temperature control devices 1264 may enable air flow through the interior of the housing 1020 in order to aid in reducing or cooling the temperature of the interior. The temperature control devices 1264 may take many active and/or passive forms, including, but not limited to, louvers, fins, thermally conductive material, endothermic reactions, phase change materials, fin tubes, micro-channel cold plates, porous or open celled foams of high thermal conductivity materials, and fans.

### Alternative Temperature Control Devices

The flow of generated oxygen through the breathing device 1000 (FIG. 1) may be substantial enough to be used as a source of energy for active thermal dissipation techniques. The breathing device 1000 may comprise a powered fan to distribute air through and around the components of the breathing device 1000. A spinner placed in the flow path may provide magnetic activation for a fan placed external to the spinner. Alternatively, a sealed arbor may be attached to a spinner placed in the flow path of the breathing device 1000. An external end of the arbor may be attached to a fan placed outside of the spinner. In other illustrative embodiments of the present invention, electric current may be generated from the rotation of a magnetic disk located in the flow path (e.g., for inductive generation of power) or from vibration resulting from the bubbling of gas through the water trap 1050 (FIG. 1) (e.g., piezo electric power). Further alternatively, the Peltier effect may be used for the thermal electric generation of a current. The Peltier effect may also be used for cooling if a current is applied.

### Cartridge

Turning now to FIG. 23, an embodiment of the present invention may comprise a replaceable cartridge 1030. The cartridge 1030 may further comprise one or more oxygen sources 40′, a water trap 1050, a top cartridge plate 1300, a self-sealing connector 1320, and a heat shield 1040. The oxygen sources 40′ may comprise reaction plungers 440′ and reaction membranes 420′. The self-sealing connector 1320 may comprise an upper connector portion 1322 and a lower connector portion 1324. The heat shield 1040 may comprise temperature control devices 1042. The cartridge 1030 may be configured to be removable and replaceable during the course of an emergency. By continuously exchanging an expired cartridge 1030 with a new cartridge 1030, a user may have a renewable supply of breathable air. The cartridge 1030 may be configured to removably fit within the interior of the housing 1020 (FIG. 1).

Turning to FIGS. 24A and 24B, the top cartridge plate 1300 may comprise activation tabs 308′, a cartridge handle 310′, chamber passageways 1302, chamber passageway connector 1304, and a inhalation tube connector orifice 1306. The activation tabs 308′ and cartridge handle 310′ may be similar to the previously described activation tabs 308 and cartridge handle 310 of an earlier embodiment (see FIG. 5A). The number of chamber passageways 1302 may correspond to the number of oxygen sources 40′. In this illustrative example, there may be two chamber passageways 1302 for the two oxygen sources 40′ of the cartridge 1030. Oxygen, catalytically produced by the oxygen source 40′, may be collected within the chamber passageway 1302 located at the top of the cartridge 1030.

The chamber passageway connector 1304 may fluidly connect two or more chamber passageways 1302. The chamber passageway connector 1304 may enable the combination of the oxygen catalytically produced by the respective oxygen sources 40′. Although the chamber passageway connector 1304 is shown as a separate component attached to the top surface of the top cartridge plate 1300, the chamber passageway connector 1304 may not be limited to this configuration. Examples of other embodiments of the chamber passageway connector 1304, include, but are not limited to, a chamber passageway connector integrally formed within the top cartridge plate 1300, a tube connecting the various chamber passageways 1302, an intermediate member such as a water trap 1050 individually attached to and connecting each chamber passageway 1302, and a tube directly connected to each oxygen source 40′ and further connected to a t-fitting, among others.

Turning now to FIG. 25, a temperature indicator 1350 may be attached the reaction chamber 400′ of each of the oxygen sources 40′. The temperature indicator 1350 may be a color changing device configured to indicate the passage of a temperature threshold by the reaction chamber 400′. Alternatively, the temperature indicator 1350 may be configured to indicate the approximate temperature of the oxygen source 40′, and therefore further comprise a numeric or pictorial scale. However, the temperature indicator 1350 may not be limited to this embodiment. Other methods and devices may be used to indicate the approximate temperature of the oxygen source 40′, including, but not limited to, mechanical and/or electronic temperature gauges, infrared devices, and phase change materials, among others.

The rest of the oxygen source 40′ may be similar to the detailed oxygen source 40 (FIG. 6) of a previous embodiment of the present invention. However, an embodiment of the present invention incorporating two or more oxygen sources 40′ may comprise an altered initiation timing and/or rate of the catalytic oxygen production from each of the oxygen sources 40′ in order to obtain a desired flow rate profile of oxygen output over a specific time period. For example, one oxygen source 40′ may supply an initial bolus of oxygen through a relatively rapid initial production of oxygen. Whereas another oxygen source 40′ may have a slower initial onset of the oxygen producing reaction but may produce a lower level of oxygen over a longer period of time. The combination of the two separate flows of catalytically produced oxygen may provide a desired flow rate profile over the longer period of time. The use of multiple oxygen sources 40′ to achieve variable or longer duration gas flow profiles is more fully described in the following patent applications, along with embodiments and components of various oxygen sources 40′. These patent applications are incorporated by reference herein as the “Ross Catalytic Oxygen Patent Applications.”

### Heat Shield

Returning to FIG. 23, the heat shield 1040 of the cartridge 1030 may comprise temperature control devices 1042, for example in the form of a plurality of orifices (e.g., slots). The temperature control devices 1042 may enable air flow through the interior of the cartridge 1030 in order to aid in reducing or cooling the temperature of the interior of the housing 1020 (FIG. 20). The temperature control devices 1042 may take many active and/or passive forms, including, but not limited to, louvers, fins, thermally conductive material, endothermic reactions, phase change materials, fin tubes, micro-channel cold plates, porous or open celled foams of high thermal conductivity materials, and fans.

### Water Trap

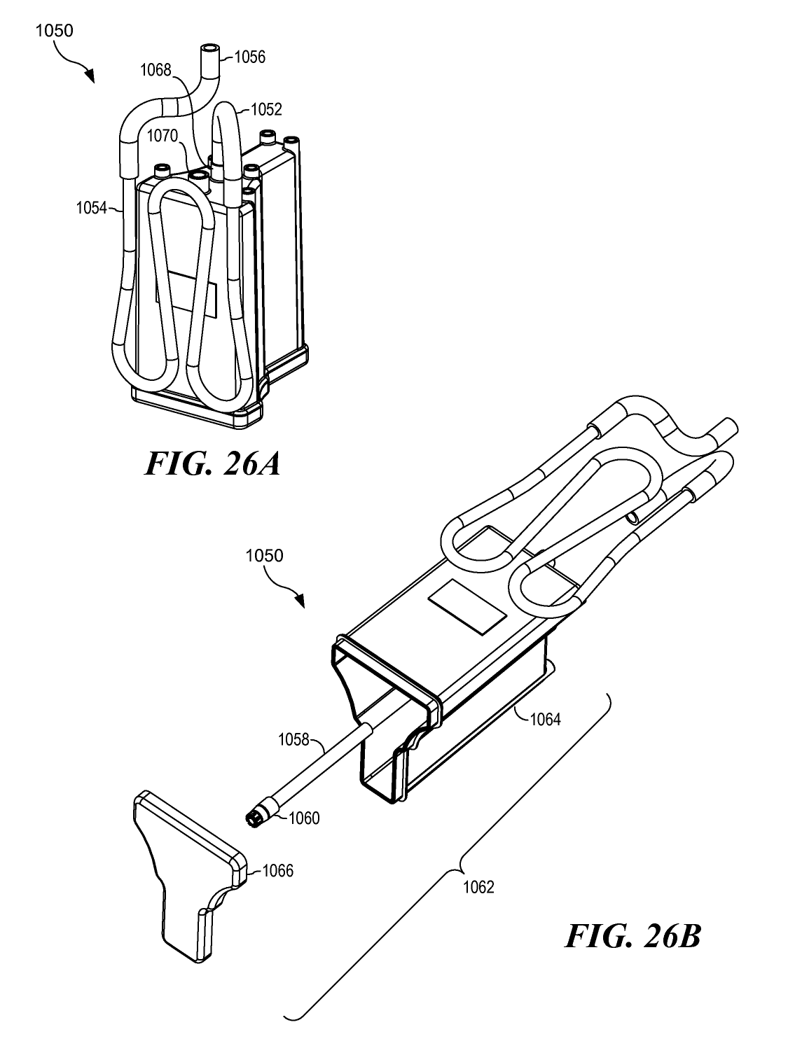

Turning now to FIGS. 26A and 26B, an illustrative embodiment of the water trap 1050 may comprise a first connector 1052, a convoluted passageway 1054, a second connector 1056, an internal connector 1058, and a multi-orifice disperser 1060. The water trap 1050 may further comprise a container 1062 comprising a container housing 1064 and a container housing end-piece 1066. The container 1062 may comprise a container inlet 1068 and a container outlet 1070.

Oxygen, generated by the oxygen source 40′ (FIG. 20) may flow into the second connector 1056. The second connector 1056 may be fluidly connected to an oxygen outlet (not shown) located on the lower surface of the top cartridge plate 1300 (FIG. 23). The oxygen may flow from the second connector 1056 into the convoluted passageway 1054. The convoluted passageway 1054 may be aluminum tubing, copper tubing, or other thermally conductive material, among others. The convoluted passageway 1054 may trap moisture carried in the oxygen gas as well as reduce the overall temperature of the oxygen gas. By disrupting the linear flow of gas with convoluted configurations, fins, or other disruptive structures or features in the flow lines (e.g., nano grass, pins, and other internal or external surface modifications) in combination with cold plates for passive dissipation of thermal energy for example, additional thermal energy may be removed from the oxygen gas. The convoluted passageway 1054 may be shown as a substantially W-shaped tube, however, spirals, loops, and U-shapes, among others, may be used. Additionally, the use of the convoluted passageway 1054 may help to restrict or inhibit the flow of liquid through the rest of the breathing device 1000 (FIG. 20).

After passing through the convoluted passageway 1054, the oxygen gas may continue on through the first connector 1052. The first and second connectors 1052 and 1056 may be flexible tubing for example. The first connector 1052 may fluidly connect the convoluted passageway 1054 to the container inlet 1068. The container inlet 1068 may be fluidly connected to the internal connector 1058 and the multi-orifice dispenser 1060. As the oxygen flows through the multi-orifice disperser 1060 via the internal connector 1058, the oxygen gas may be bubbled through a liquid disposed within the container 1062. As a result, thermal energy may be stripped from the gas flow through the condensation of steam produced during the bubbling process.

The bubbled oxygen gas may then leave the container 1062 via the container outlet 1070. The container outlet 1070 may be fluidly coupled to the self-sealing connector 1320 (FIG. 23). Although one container outlet 1070 is shown in this exemplary embodiment, two or more container outlets 1070 may be used to facilitate non-clogging/continuous flow through the breathing system 1000 even if one or more container outlets 1070 are clogged. For example, a container outlet 1070 may become clogged if the system is not upright during activation, for example. Alternatively, spiral or other convoluted passageways may be placed between the self-sealing connector 1320 and the container outlet 1070 to further alter the temperature of the oxygen gas. However, a convoluted passageway placed after the water trap 1050 may be less effective than the convoluted passageway 1054

The water trap 1050 may comprise sodium acetate or other phase change materials (PCM), for example, within the water contained in the water trap 1050 in order to facilitate increased thermal management of the generated oxygen. Some illustrative embodiments may comprise materials configured to change phase via endothermic reactions, thereby lowering the temperature of the liquid in the water trap 1050 and enhancing the ability of the water trap 1050 to cool the generated oxygen gas and condense out water vapor from the gas. The phase change materials may be inside or outside of the container 1062. The phase change materials may surround the convoluted passageway 1054 and/or other gas flow passageways. In addition to or alternatively, cooling packets may be added to the water trap 1050 at activation of the breathing device 1000 (FIG. 20). For example, one embodiment of the present invention may comprise adding potassium chloride to the water trap 1050 at the time of activation. Also, an acetic acid reaction may facilitate steam removal and cooling potential in addition to providing a citrus scent to the gas flow. Additional additives may be added to the liquid contained within the water trap 1050 in order to flavor or otherwise enhance the generated oxygen gas. Examples of some of the additional additives include, but are not limited to, nutriceuticals, vitamins, pharmaceuticals, basic oils, and herbal extracts among others.

### Self-Sealing Connector

Returning to FIG. 23, the self-sealing connector 1320 may comprise an upper connector portion 1322, and a lower connector portion 1324. When the upper connector portion 1322 is disconnected from the lower connector portion 1324, the lower connector portion 1324 may inhibit or prevent fluid flow through the body of the lower connector portion 1324. When the upper connector portion 1322 is connected to the lower connector portion 1324, the self-sealing connector 1320 may facilitate fluid flow through internal passageways of the self-sealing connector 1320. A commercially available self-sealing connector 1320 produced by the Colder Products Company® (CPC) may be used.

When the upper connector portion 1322 is disconnected from the lower connector portion, the upper connector portion 1322 may inhibit or prevent the flow of fluid through the body of the upper connector portion 1322. Alternatively, the upper connector portion 1322 may only allow fluid to flow in a substantially unidirectional flow, for example, out of the upper connector portion 1322. Although the self-sealing and one-way valve connection is described as a single self-sealing connector 1320, the self-sealing connector 1320 may comprise two or more individual valves successively joined together.

### Activation Mechanism

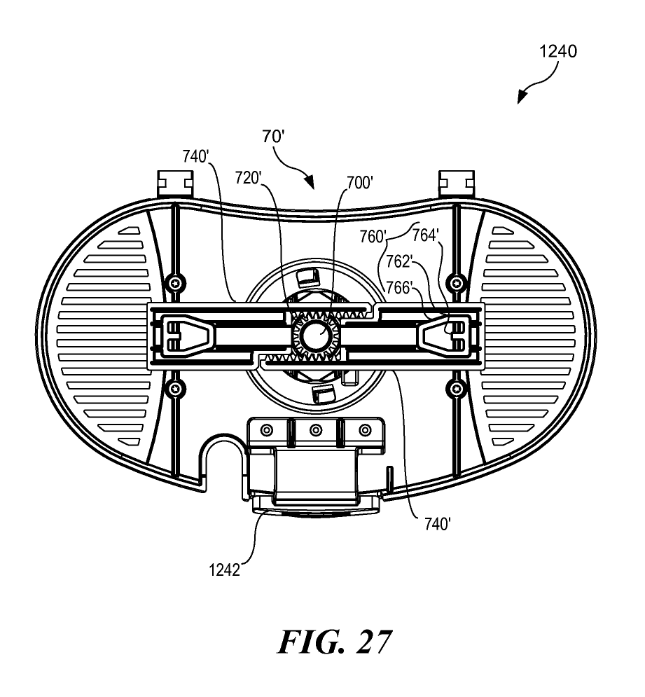

Turning now to FIG. 27, the top housing 1240 may comprise components of the activation mechanism 70′. The actuator 700′, such as a knob for example, may be rotatively coupled to the top housing 1240. The actuator 700′ may further be resiliently coupled to a spring (not shown) so that the actuator 700′ is biased in a direction opposed to actuation. In addition, the actuator 700′ may be locked in place via an easily removable cotter pin (not shown) or other such device. By resiliently coupling the actuator 700′, the occurrence of accidental activations may be reduced, while still enabling a user to easily actuate the breathing device 1000 (FIG. 20).

The actuator 700′ may be coupled with an activating gear 720′. Rotation of the actuator 700′ may correspondingly rotate the activating gear 720′. The activating gear 720′ may be translatingly coupled to one or more activating plates 740′ (two are shown in this illustrative embodiment). The activating plates 740′ may each comprise an activating orifice 760′. As shown in FIG. 27, each activating orifice 760′ may comprise an approximately rectangular section 762′ partially divided by a protrusion 764′, and a narrowing wedging section 766′. When the top housing 1240 is closed upon an installed cartridge 1030 (FIG. 20) by pivoting the top housing 1240 about hinges 1202, the activation tabs 308′ (FIG. 24A) may be inserted into the rectangular sections 762′ of the activating orifices 760′, on either side of the protrusions 764′. Each protrusion 764′ may maintain the activation tabs 308′ in a separated state, coupled with the top cartridge plate 1300 (FIG. 24A), thereby inhibiting inadvertent or accidental activation of the cartridge 1030 (FIG. 20). The top housing 1240 may be retained in a closed position by the U-shaped tab 1242.

Rotating the actuator 700′ in this illustrative embodiment may cause the activating orifice 760′ to translate with respect to the activating tabs 308′ (FIG. 24A). In such a case, the protrusion 764′ may be withdrawn from between the activating tabs 308′. The activating tabs 308′ may then be slidably repositioned into the narrowing wedging section 766′ of the activating orifice 760′. The side walls of the narrowing wedging section 766′ of the activating orifice 760′ may force the activating tabs 308′ closer to one another, actuating the oxygen sources 40′ (FIG. 20).

The illustrative embodiment of the present invention may use a rotating knob actuator 700′ and activating plates 740′ as an example of how to actuate a cartridge 1030 (FIG. 20). However, many methods and mechanisms may be used to actuate a cartridge 1030. Embodiments of the breathing device 1000 (FIG. 20) may comprise levers, push buttons, electro-mechanical solenoids, and key mechanisms, among others. A simple activation process may be configured to enable a wide range of consumers to use the system in a medical or other applicable emergency. A simple activation process may also minimize the potential for improper use or mistake by users who may already be under tremendous amounts of psychological and physical stress as a result of an emergency situation. Other examples of activation mechanisms 70′ and methods may be found in the Ross Catalytic Oxygen patent applications previously listed and incorporated herein by reference.

### Utilization

Turning now to FIG. 28, when faced with a pressing need for oxygen, such as at an athletic event, medical emergency, surrounding hazardous environment, among others, a user may take a breathing device 1000 from a storage area. The user may remove the storage cover 1090 from the top of the housing 1020 (see FIG. 20). The storage cover 1090 may be removably fixed to the top of the housing 1020 via a snap fit, clasp, strap, clip, or hinge, among others. The removal of the storage cover 1090 may expose the top housing 1240 and the actuator 700′. Further, the breathing apparatus 1840 and inhalation tube 800′ may be stored within the storage cover 1090. The storage cover 1090 may be transparent to facilitate the detection and identification of the breathing apparatus 1840 and inhalation tube 800′.

The user may determine if the housing 1020 was stored with a cartridge 1030 preinstalled (see FIG. 20). If no cartridge 1030 is present within the housing 1020, the user may retrieve a cartridge 1030, remove anti-activation devices 940′ (FIG. 24B), open the top housing 1240, and insert the cartridge 1030 within the housing 1020. The user may then close the top housing 1240, engaging the activation mechanism 70′ (FIG. 20) with the activation tabs 308′ (FIG. 24A). As with the breathing device 100 (FIG. 1), in the interest of reducing the time needed to provide oxygen to a user, a cartridge 1030 may be typically installed within the housing 1020 and stored as a complete breathing device 1000. After a cartridge 1030 has been installed in a housing 1020 or is determined to already be installed in a housing 1020 (see FIG. 20), the user may attach the inhalation tube 800′ to the self-sealing connector 1320 (FIG. 23) and the breathing apparatus 1840.

The breathing apparatus 1840 may comprise a face mask 1842 configured to sealingly cover the mouth and nose of a user, and a strap 1848 for attaching the face mask 1842 to the user. The face mask 1842 may comprise an inhalation inlet 1844 for attaching the inhalation tube 800′, and an expiration outlet 1846, for exhausting expiration air. The one-way inlet valve 1870 may result in a substantially unidirectional flow of oxygen gas through the inhalation tube 800′. The expiration air and excess oxygen gas may be expelled through the expiration air outlet 1846 via the one-way outlet valve 1872. The one-way outlet valve 1872 may help to inhibit or prevent a user's exposure to the surrounding ambient environment, which may be beneficial in the case of a toxic or hazardous ambient environment. A single two-way valve or wye-connector may be used in place of the two one-way valves.

Initiation of the catalytic oxygen producing reaction may comprise the user executing one partial rotation of the actuator 700′ (e.g., a knob rotatably connected to the top housing 1240) or a push of a button or the lifting of a lever. The breathing device 1000 may be self-sustaining in that activation and use does not require any additional tools or supplemental energy input from power sources such as a battery. However, the addition of supplemental power to a breathing device 1000 may facilitate adding optional additional features such as indicators, timers, reaction initiation, or enhanced thermal management, among others.

The exemplary embodiment of the present invention may incorporate the use of interchangeable disposable cartridges 1030 configured with appropriate tolerances to facilitate consistent and reliable functioning of the activation mechanism 70′ for any and all of the cartridges 1030 (see FIG. 20). The top housing 1240 assembly comprising the activation mechanism 70′ may be held in place by a locking interface in two or more places with the remaining housing 1020 components. The hinges 1202 and the U-shaped tab 1242 may hold the top housing 1240 (see FIG. 22A) in place parallel to the top cartridge plate 1300 (FIG. 24A), thereby facilitating an interface between the activation tabs 308′ (FIG. 24A) and the activation orifices 760′ (FIG. 27). Supporting ribs, gussets, and other structures may be incorporated into the top housing 1240 in order to increase the stiffness of the top housing 1240.

After commencing the catalytic production of oxygen, the face mask 1842 may be sealingly attached to the face of a user via the strap 1848. The user may then breathe normally. Excess oxygen may exit the face mask 1842 via the outlet 1846, along with any expiration air.

In order to replace a cartridge 1030, a user may retrieve a new cartridge 1030 from the storage location and remove the anti-activation devices 940′ (see FIG. 24B). The user may open the top housing 1240 and disconnect the inhalation tube 800′ from the self-sealing connector 1320 (FIG. 23). The cartridge 1030 may be removed and replaced with the new cartridge 1030. The inhalation tube 800′ may be re-connected to the new cartridge 1030. The top housing 1240 may be closed. The actuator 700′ may be partially rotated to activate the new cartridge 1030. This process may be repeated for as long as there exists additional un-used cartridges 1030 and a need for supplemental oxygen.

### Alternative Embodiments

In the detailed illustrative embodiments, the lower inhalation tube 802 was described as potentially being internal to the housing 20 and attached to the rear surface of the front housing 220 (see FIG. 2). However, the lower inhalation tube 802 may not be limited to this configuration. Placement of the lower inhalation tube 802 may be made on the basis of parameters such as manufacturing and/or packaging constraints, among others. As one example, the lower inhalation tube 802 may be attached to the front surface of the front housing 220. This configuration may eliminate the need for a separate housing notch 246 and passageway accommodators 216. Additionally, the lower inhalation tube 802 may comprise temperature control devices, such as, but not limited to, thermally conducive fins, extended passageways, and passage through heat absorbing materials for example.

In the detailed illustrative embodiments, temperature control devices 228 and 248 were shown potentially located on the top housing 240 and the front housing 220 (see FIG. 2). However, temperature control devices may be used on any combination of components and configurations of breathing device 100 (FIG. 1).

In the detailed illustrative embodiments, the first covering 422 of the reaction membrane 420 may be impervious to liquid (see FIGS. 7A-7C). However, the first covering 422 may further be gas permeably, thereby reducing or eliminating the need for piercing of the first covering 422 by the second cutting edge 444 of the reaction plunger 440. The reaction plunger 440 may be configured so as to maintain the integrity of the first covering 422 during actuation.

In the detailed illustrative embodiments, the bottom housing member 260 may be slidably engaged with the lower portions of the rear housing 200 and the front housing 220 (see FIG. 2). However, the bottom housing member 260 may be fixedly attached to the reservoir container 600. In addition, the bottom housing member 260 may comprise the pressure relief valve 640 of the reservoir bag 60 (see FIG. 12). The attachment of the bottom housing member 260 may allow temperature control devices integrated with the bottom housing member 260 to more efficiently transfer heat within the reservoir container 600 to the surrounding environment. Further, integrating the pressure relief valve 640 with the bottom housing member 260 may provide a more secure and stable platform for mounting of the pressure relief valve 640.

In the detailed illustrative embodiments, the breathing apparatus 840 may be fluidly coupled with the housing 20 via an inhalation tube 800 and an expiration tube 820 (see FIG. 14). However, some embodiments of the present invention may have the breathing apparatus 840 substantially directly connected to the housing 20. In this case, the breathing device 100 may be coupled to the user via the breathing apparatus 840.

In the detailed illustrative embodiments, the breathing apparatus 840 (FIG. 14) may comprise a water trap to remove excess moisture from the gas flow. However, in order to further trap and/or reduce the amount of excess moisture within the gas flowing through the breathing device, plenums and hydroscopic filters may be added in the flow path of the gas. The use of plenums and hydroscopic filters may help to remove or screen excessive moisture from the gas. However, not all of the moisture may be removed from the gas within the breathing device. Among the benefits of the high humidity of the reaction may be that the humidity significantly lowers the chance for a spark or other ignition source (i.e., internal or external) from initiating combustion in the pure oxygen environment inside of the chamber and gas flow path after activation. Although the breathing device may remove excess moisture, there may not be any significant efforts to completely dry out the oxygen. Even after going through the water trap, coiled tubing, and hydrophobic filters there may still enough water vapor to condense in the air line leading to the breather mask. The presence of moisture may be one of the enabling factors in the use of polymers as the container and gas flow channel.

Having thus described embodiments of the present invention by reference to certain exemplary embodiments, it is noted that the embodiments disclosed are illustrative rather than limiting in nature. A wide range of variations, modifications, changes, and substitutions are contemplated in the foregoing disclosure. In some instances, some features of an embodiment of the present invention may be employed without a corresponding use of the other features. Many such variations and modifications may be considered desirable by those skilled in the art based upon a review of the foregoing description of the illustrative embodiments. Accordingly, it is appropriate that the appended claims be construed broadly and in a manner consistent with the scope of the invention.

We claim:

1. A system for providing sustaining air, the system comprises:
a sealed housing;
an oxygen source configured to catalytically produce a gas that comprises oxygen;
a breathing interface configured to provide the sustaining air to the user from the sealed housing;
an activation mechanism configured to commence production of the gas by the oxygen source upon manual displacement at a location external to the housing.

2. The system of claim 1 wherein the oxygen source comprises:
a membrane that separates an accelerant, a catalyst, and a reagent, from one another, in which the membrane comprises:
a storage compartment sealed by a first covering and a second covering;
a container member that comprises catalyst and is contained within the storage compartment;
a catalyst dispersal device configured to actively disperse the catalyst within the container upon operation of the activation mechanism; and
a plunger configured to interact with the membrane to combine the accelerant, the catalyst, and the reagent, upon operation of the activation mechanism.

3. The system of claim 2 wherein the catalyst dispersion device comprises a resilient member that interacts with the container member and the membrane so as to rotate the container member upon operation of the activation mechanism.

4. The system of claim 2 wherein the resilient member interacts with the container member and the membrane so as to rotate the container member while the container member is ejected from within the storage compartment upon operation of the activation mechanism.

5. The system of claim 2 wherein the resilient member interacts with the container member and the membrane so as to rotate the container member while the container member remains at least partially within the storage compartment of the membrane upon operation of the activation mechanism.

6. The system of claim 1 wherein the cartridge further comprises a water trap wherein the gas is bubbled through a liquid contained within the water trap prior to delivery of a bubbled gas to the breathing apparatus.

7. The system of claim 6 wherein the liquid contained within the water trap comprises an additive to alter a phase transition temperature of the liquid.

8. The system of claim 6 wherein the water trap comprises two or more exits for the bubbled gas.

9. The system of claim 1 wherein the system further comprises a convoluted tube as a section of a flow path of the gas.

10. The system of claim 9 wherein the convoluted tube comprises copper.

11. The system of claim 2, wherein the plunger breaches the membrane upon operation of the activation mechanism.

12. The system of claim 1, wherein the housing further comprises a pivotal housing member configured to openly close off an interior of the housing; and
wherein the oxygen source is removably inserted into the interior of the housing via the pivotal housing member.

13. The system of claim 8, wherein the pivotal housing member comprises the activation mechanism configured such that the closing of the pivotal housing member over the oxygen source contained within the housing engages an activation tab of the oxygen source with the activation mechanism.

14. A method for using a breathing device that comprises:
removing a storage cover from a breathing device;
attaching an inhalation tube to an oxygen source;
attaching the inhalation tube to a breathing apparatus;
activating the oxygen source;
attaching the breathing apparatus to a user; and
breathing sustaining air in from the inhalation tube and expiring expiration air out through the breathing apparatus.

15. The method of claim 14 wherein the oxygen source comprises:
a plunger;
a membrane that comprises a storage container that comprises a container member that comprises catalyst;
a catalyst dispersal device interacting with the container member;
wherein the activating of the oxygen source comprises:
breaching the membrane with the plunger;
forcing the container member to exit the storage container via the plunger; and
dispersing the catalyst from within the container member via the catalyst dispersal device during the exit from the storage container.

16. The method of claim 15 wherein the catalyst dispersal device comprises a resilient spring interacting with the container member and the storage container to rotate the container member during exit from the storage container.

17. The method of claim 14 further comprising checking a temperature indicator attached to the cartridge to verify activation of the oxygen source.

18. A cartridge for a breathing device, the cartridge comprises:
an oxygen source configured to catalytically produce a gas that comprises oxygen;
an activation interface configured to interact with an activation mechanism of a breathing device;
an gas interface configured to provide the gas to the breathing device;
wherein the oxygen source further comprises:
a plunger;
a membrane that comprises:
a container sealed within a storage section by a first covering and a second covering;
a resilient member coupled to the container and the storage section and configured to rotate the container as the container is driven out of the membrane after activation of the activation mechanism of the breathing device.

19. The cartridge of claim 17, wherein the cartridge further comprises a water trap configured to bubble the gas through a liquid contained within the water trap prior to the gas being provided to the breathing device.

20. The cartridge of claim 18, wherein the liquid comprises an additive to alter a phase transition temperature of the liquid.

21. The cartridge of claim 19, wherein the additive is NaCl.
